(19) United States
(12) Patent Application Publication
(10) Pub. No.: US 2026/0167003 A1
(43) Pub. Date: Jun. 18, 2026

(54) VEHICLE CONTROL DEVICE, VEHICLE CONTROL METHOD, AND NON-TRANSITORY COMPUTER READABLE STORAGE MEDIUM

(71) Applicant: DENSO CORPORATION, Kariya-city (JP)

(72) Inventors: Shigeru KAMIO, Kariya-city (JP); Akihiro TAKAHASHI, Kariya-city (JP); Ryuichi MAKI, Kariya-city (JP)

(21) Appl. No.: 19/433,542

(22) Filed: Dec. 26, 2025

Related U.S. Application Data
(63) Continuation of application No. PCT/JP2024/015907, filed on Apr. 23, 2024.

(30) Foreign Application Priority Data
Jul. 5, 2023 (JP) 2023-110900

(51) Int. Cl. B60L 3/00

(52) U.S. Cl. CPC B60L 3/0061; B60L 2240/423; B60L 2240/425

(57) ABSTRACT

A vehicle control device is configured to estimate temperature of a drive device, which includes a rotary electrical machine configured to drive a vehicle and an inverter connected to the rotary electrical machine, based on a temperature detection value of at least one of power elements of the inverter and a current value of each of the power elements, and control torque of the rotary electrical machine based on the temperature as estimated to decrease temperature of the drive device when the drive device is overloaded.

### CROSS REFERENCE TO RELATED APPLICATION

The present application is a continuation application of International Patent Application No. PCT/JP2024/015907 filed on Apr. 23, 2024, which designated the U.S. and claims the benefit of priority from Japanese Patent Application No. 2023-110900 filed on Jul. 5, 2023. The entire disclosures of all of the above applications are incorporated herein by reference.

### TECHNICAL FIELD

The present disclosure relates to a vehicle control device, a vehicle control method, and a non-transitory computer readable storage medium.

### BACKGROUND

Conventionally, a control device that controls an actuator of a vehicle is known.

### SUMMARY

According to an aspect of the present disclosure, a vehicle control device comprises: at least one of (i) a circuit and (ii) a processor with a memory storing computer program code executable by the processor. The at least one of the circuit and the processor may be configured to cause the vehicle control device to: estimate temperature of a drive device, which includes a rotary electrical machine configured to drive a vehicle and an inverter connected to the rotary electrical machine, based on a temperature detection value of at least one power element of a plurality of the power elements of the inverter and a current value of each of the power elements; and in a state in which the drive device is overloaded, control torque of the rotary electrical machine based on the temperature as estimated to decrease temperature of the drive device.

### BRIEF DESCRIPTION OF THE DRAWINGS

FIG. 1 is a schematic diagram illustrating an example of a configuration of a vehicle.

FIG. 2 is a block diagram illustrating an example of a hardware configuration of a vehicle control device.

FIG. 3 is a block diagram illustrating an example of a sensor group.

FIG. 4 is a block diagram illustrating an example of a functional configuration of a CPU.

FIG. 5 is a block diagram illustrating an example of functional units constituting a protection control unit in more detail.

FIG. 6 is a circuit configuration diagram illustrating an example of a drive device.

FIG. 7 is a flowchart illustrating an example of protection control processing.

FIG. 8 is a flowchart illustrating an example of level difference ride-over control processing.

FIG. 9 is a flowchart illustrating an example of torque selection processing.

FIG. 10 is a flowchart illustrating an example of temperature estimation processing.

FIG. 11 is a timing chart illustrating an example of an operation of temperature estimation processing.

FIG. 12 is a flowchart illustrating a modification of temperature estimation processing.

FIG. 13 is a flowchart illustrating an example of single-phase continuous energization determination processing.

FIG. 14 is a flowchart illustrating an example of overheat protection determination processing.

FIG. 15 is a flowchart illustrating an example of accelerator hill hold countermeasure processing.

FIG. 16 is a flowchart illustrating a modification of the accelerator hill hold countermeasure processing.

FIG. 17 is a block diagram illustrating a modification of the functional configuration of the CPU.

FIG. 18 is a flowchart illustrating an example of overheat protection control processing.

FIG. 19 is a first explanatory diagram illustrating an example of operation of an overheat protection control unit.

FIG. 20 is a second explanatory diagram illustrating an example of an operation of the overheat protection control unit.

FIG. 21 is a flowchart illustrating a modification of a part of the overheat protection control processing.

FIG. 22 is a timing chart illustrating an example of an operation of a part of the overheat protection control processing.

FIG. 23 is an explanatory diagram illustrating an example of an operation of filtering processing.

FIG. 24 is a first flowchart illustrating an example of permission determination processing.

FIG. 25 is a second flowchart illustrating an example of the permission determination processing.

FIG. 26 is a graph illustrating an example of determination threshold map data.

FIG. 27 is a flowchart illustrating an example of level difference estimation processing.

FIG. 28 is a side view illustrating an example of a state in which a wheel is in contact with a level difference.

FIG. 29 is a graph illustrating an example of a trajectory and a trajectory angle of a rotation center axis of a wheel.

FIG. 30 is a flowchart illustrating an example of single-wheel and two-wheel run-on determination processing.

FIG. 31 is a flowchart illustrating an example of stepping error determination processing.

FIG. 32 is a flowchart illustrating an example of ride-over prohibition control.

FIG. 33 is a diagram illustrating an example of a relationship among a vehicle speed, a level difference height, and level difference ride-over control.

### DETAILED DESCRIPTION

A vehicle control device according to an example of the present disclosure includes a first electric motor, an actuator, and a switching mechanism. The first electric motor has a plurality of energization phases, and generates a torque by controlling a current value for energizing each energization phase of the plurality of energization phases in accordance with a rotation angle. The actuator can output a torque for maintaining a vehicle in a stop state. The switching mechanism can have a state switched between an engaged state in which a torque is transmitted in a transmission path in which the torque output from the first electric motor is transmitted to a drive wheel and a disengaged state in which the torque is cut off.

The vehicle control device includes a controller that controls the actuator and the switching mechanism. The controller is configured to execute energization phase change control of changing the rotation angle of the first electric motor to lower a thermal load of a predetermined energization phase in a case where it is determined that the thermal load of any one predetermined energization phase of the plurality of energization phases becomes more than or equal to a predetermined value by outputting a predetermined torque and maintaining a stopped state in a state where the rotation of the first electric motor is stopped. The energization phase change control is configured to be executed while the switching mechanism is switched to the disengaged state and a torque for maintaining the vehicle stopped state is output by the actuator.

As a result of detailed studies by the inventors, the following problems have been found. That is, if it is determined whether a drive device including a rotary electrical machine and an inverter becomes an overloaded state and is overheated, for example, on the basis of only the value of the current supplied from the inverter to the rotary electrical machine, there is a possibility that it cannot be accurately determined whether the drive device is overheated because the influence of heat exchange between the drive device and the outside is not considered.

In addition, when the drive device becomes an overloaded state and the vehicle stops, the drive device is in a single-phase continuous energization state in which the current continuously flows in any one of the plurality of phases, and the phase in which the current concentrates increases three times as compared with the case where the thermal load is not overloaded. Here, if it is determined whether the drive device is overheated, for example, only on the basis of the current value detected by a current sensor provided to any one of the plurality of phases, there is a case where the phase in which the current value is obtained is different from the phase in which the current continuously flows, and in this case, there is a possibility that it cannot be accurately determined whether the drive device is overheated.

In a case where it is not possible to accurately determine whether the drive device is overheated as described above, there is a possibility that control for lowering the temperature of the drive device cannot be performed at an appropriate timing.

A vehicle control device according to an example of the present disclosure includes: an estimation unit that estimates temperature of a drive device, which includes a rotary electrical machine configured to drive a vehicle and an inverter connected to the rotary electrical machine, based on a temperature detection value of at least one power element of a plurality of the power elements of the inverter and a current value of each of the power elements; and a control unit that controls, in a state in which the drive device is overloaded, torque of the rotary electrical machine based on the temperature as estimated to decrease temperature of the drive device.

A vehicle control device according to an example of the present disclosure includes: a determination unit that determines, when a vehicle rides over a level difference or travels on an uphill road, whether the vehicle is in a stopped state due to load torque, which acts on a rotary electrical machine driving the vehicle and balances with torque of the rotary electrical machine; a setting unit that sets, when determining that the vehicle is in the stopped state, a target speed of the vehicle in accordance with an operation amount of an accelerator pedal provided to the vehicle; and an arithmetic operation unit that calculates target torque of the rotary electrical machine when executing feedback control to cause an actual vehicle speed of the vehicle to become the target speed.

A vehicle control method according to an example of the present disclosure includes: estimating, by at least one processor, temperature of a drive device, which includes a rotary electrical machine configured to drive a vehicle and an inverter connected to the rotary electrical machine, based on a temperature detection value of at least one of a plurality of the power elements of the inverter and a current value of each of the power elements; and in a state in which the drive device is overloaded, controlling, by the at least one processor, torque of the rotary electrical machine based on the temperature as estimated to decrease temperature of the drive device.

A vehicle control method according to an example of the present disclosure includes: determining, by at least one processor, when a vehicle rides over a level difference or travels on an uphill road, whether the vehicle is in a stopped state due to load torque, which acts on a rotary electrical machine driving the vehicle and balances with torque of the rotary electrical machine; setting, by the at least one processor, when determining that the vehicle is in the stopped state, a target speed of the vehicle in accordance with an operation amount of an accelerator pedal provided to the vehicle; and calculating, by the at least one processor, target torque of the rotary electrical machine when executing feedback control to cause an actual vehicle speed of the vehicle to become the target speed.

A vehicle control program according to an example of the present disclosure is configured to cause at least one processor to: estimate temperature of a drive device, which includes a rotary electrical machine configured to drive a vehicle and an inverter connected to the rotary electrical machine, based on a temperature detection value of at least one of a plurality of the power elements of the inverter and a current value of each of the power elements; and control, in a state in which the drive device is overloaded, torque of the rotary electrical machine based on the temperature as estimated to decrease temperature of the drive device.

A vehicle control program according to an example of the present disclosure is configured to cause at least one processor to: determine, when a vehicle rides over a level difference or travels on an uphill road, whether the vehicle is in a stopped state due to load torque, which acts on a rotary electrical machine driving the vehicle and balances with torque of the rotary electrical machine; set, when determining that the vehicle is in the stopped state, a target speed of the vehicle in accordance with an operation amount of an accelerator pedal provided to the vehicle; and calculate target torque of the rotary electrical machine when executing feedback control to cause an actual vehicle speed of the vehicle to become the target speed.

According to the present disclosure, there are provided a vehicle control device, a vehicle control method, and a storage medium storing a vehicle control program that are able to perform control for lowering the temperature of a drive device at an appropriate timing by accurately determining whether the drive device is overheated.

Hereinafter, the present embodiment will be described with reference to the accompanying drawings. In order to facilitate understanding of the description, the same constituents in the drawings are denoted by the same reference numerals as much as possible, and redundant description is omitted.

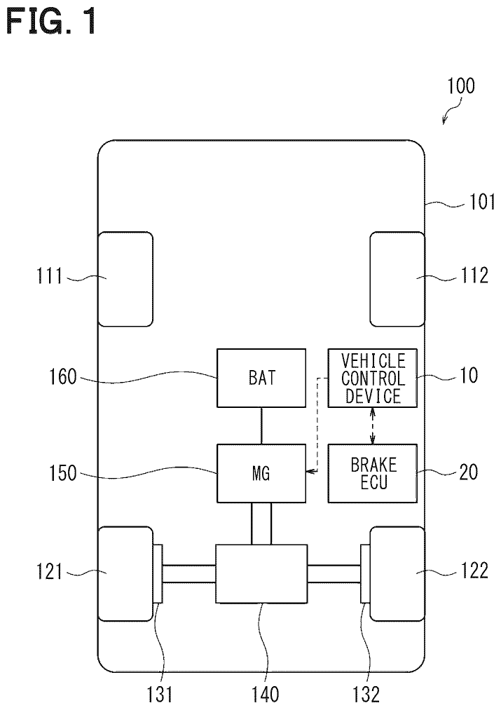

A vehicle control device 10 according to the present embodiment is mounted on a vehicle 100, and is configured as a device for performing control and the like of the vehicle 100. Prior to description of vehicle control device 10, a configuration of the vehicle 100 will be first described with reference to FIG. 1.

The vehicle 100 is a vehicle that travels on the basis on a driving operation by a driver. However, in a case where a wheel comes into contact with a level difference or the like, a part of the driving operation (for example, braking) is automatically performed by the vehicle control device 10 in some cases. The vehicle 100 includes a vehicle body 101, wheels 111, 112, 121, and 122, a rotary electrical machine 150, and a battery 160.

The vehicle body 101 is a main body portion of the vehicle 100, and is a portion called a “body”. The wheel 111 is a wheel provided in a front left side portion of the vehicle body 101, and the wheel 112 is a wheel provided in a front right side portion of the vehicle body 101. The wheels 111 and 112, which are front wheels, are provided as driven wheels in the present embodiment.

The wheel 121 is a wheel provided in a rear left side portion of the vehicle body 101, and the wheel 122 is a wheel provided in a rear right side portion of the vehicle body 101. The wheels 121 and 122, which are rear wheels, are provided as drive wheels in the present embodiment. That is, the wheels 121 and 122 rotate by the driving force of the rotary electrical machine 150 described later, and cause the vehicle 100 to travel.

As described above, the vehicle 100 of the present embodiment is configured as a so-called “rear wheel drive” vehicle. Instead of such an aspect, the vehicle 100 may be configured as a front wheel drive vehicle or a four-wheel drive vehicle. In the latter case, in addition to the rotary electrical machine 150 for driving the rear wheels, a rotary electrical machine 150 for driving the front wheels may be separately provided.

The wheel 121 is provided with a brake device 131, and the wheel 122 is provided with a brake device 132. Each of the brake devices 131 and 132 is a brake device that applies a braking force to the wheel by hydraulic pressure. Such a braking device may be provided not only on the drive wheel but also on the wheels 111 and 112 which are driven wheels. The operations of the brake devices 131 and 132 are controlled by a brake electronic control unit (ECU) 20 described later.

The rotary electrical machine 150 is a device that receives power supply from the battery 160 described later and generates a driving force for rotating the wheels 121 and 122, that is, a driving force necessary for the vehicle 100 to travel. The rotary electrical machine 150 is a so-called “motor generator” as an example. The driving force generated by the rotary electrical machine 150 is transmitted to each of the wheels 121 and 122 via a power train unit 140 to rotate the wheels 121 and 122. The transfer of power between the battery 160 and the rotary electrical machine 150 is performed via an inverter described later, but the inverter is not illustrated in FIG. 1.

The rotary electrical machine 150 can generate a driving force for accelerating the vehicle 100 and can also generate a braking force for decelerating the vehicle 100 by regeneration. Braking of the vehicle 100 can be performed by the rotary electrical machine 150 or by the brake devices 131 and 132 described above.

The battery 160 is a storage battery for supplying driving power to the rotary electrical machine 150. In the present embodiment, as an example, a lithium ion battery is used as the battery 160. The regenerative power generated in the rotary electrical machine 150 at the time of braking is supplied to the battery 160 via the inverter to charge the battery 160.

The vehicle 100 is provided with the brake ECU 20 separately from the vehicle control device 10. Both the vehicle control device 10 and the brake ECU 20 are configured as a computer system including a CPU, a ROM, a RAM, and the like. These devices can perform bidirectional communication with each other via a network provided in the vehicle 100. Details of a hardware configuration of the vehicle control device 10 will be described later.

The brake ECU 20 performs processing of controlling operations of the brake devices 131 and 132 in accordance with an instruction from the vehicle control device 10.

The vehicle control device 10 and the brake ECU 20 may not be provided as two separate devices as in the present embodiment. For example, the function of the brake ECU 20 may be integrated in the vehicle control device 10. In order to realize the function of the vehicle control device 10 described later, a specific device configuration thereof is not particularly limited.

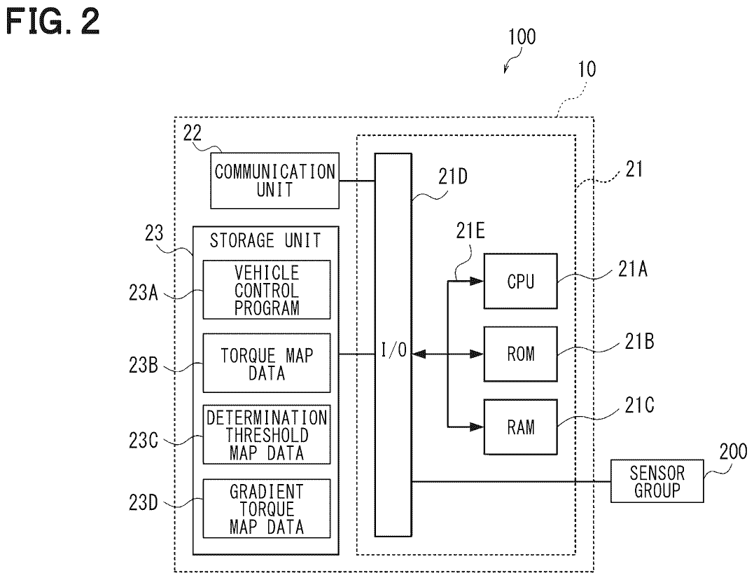

FIG. 2 is a block diagram illustrating a hardware configuration of the vehicle control device 10. As illustrated in FIG. 2, the vehicle control device 10 includes a control unit 21. The control unit 21 includes a device including a general computer.

The control unit 21 includes a central processing unit (CPU) 21A, a read only memory (ROM) 21B, a random access memory (RAM) 21C, and an input/output interface (I/O) 21D. The CPU 21A, the ROM 21B, the RAM 21C, and the I/O 21D are connected via a bus 21E. The bus 21E includes a control bus, an address bus, a data bus, and the like.

A communication unit 22, a storage unit 23, and a sensor group 200 are connected to the I/O 21D.

The communication unit 22 is an interface for communicating with external devices such as the brake ECU 20 and the rotary electrical machine 150.

The storage unit 23 includes a non-volatile external storage device such as a hard disk. The storage unit 23 stores a vehicle control program 23A, torque map data 23B, determination threshold map data 23C, gradient torque map data 23D, and the like.

The CPU 21A is an example of a computer. The computer herein refers to a processor in a broad sense, and includes a general-purpose processor (for example, the CPU) or a dedicated processor (for example, Graphics Processing Unit (GPU), Application Specific Integrated Circuit: (ASIC), Field Programmable Gate Array (FPGA), Programmable Logic Device, and the like).

The vehicle control program 23A may be stored in the storage unit 23 by being stored in a non-volatile non-transitory recording medium or distributed via a network and appropriately installed in the vehicle control device 10. The vehicle control program 23A may be appropriately updated by so-called over the air (OTA).

Examples of the non-volatile non-transitory recording medium include a compact disc read only memory (CD-ROM), a magneto-optical disk, a hard disk drive (HDD), a digital versatile disc read only memory (DVD-ROM), a flash memory, a memory card, and the like.

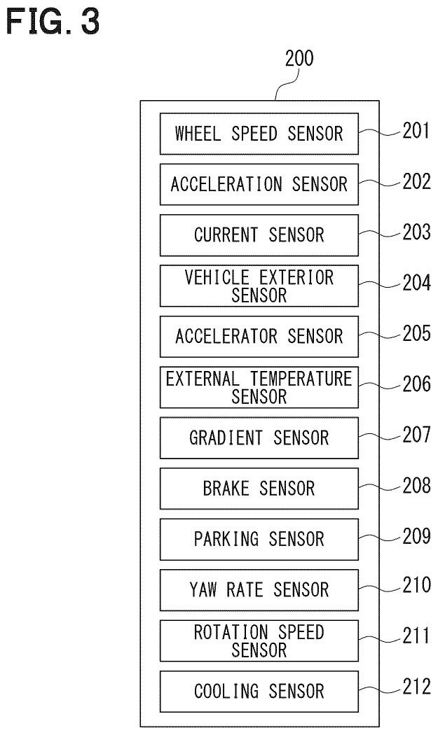

The vehicle 100 is provided with a large number of sensors for measuring various physical quantities, and as illustrated in FIG. 3, the sensor group 200 includes a wheel speed sensor 201, an acceleration sensor 202, a current sensor 203, a vehicle exterior camera 204, an accelerator sensor 205, an external temperature sensor 206, a gradient sensor 207, a brake sensor 208, a parking sensor 209, a yaw rate sensor 210, a rotation speed sensor 211, a cooling sensor 212, and the like.

The wheel speed sensor 201 is a sensor for measuring the rotation speed per unit time of the wheels 111 and the like. Although the wheel speed sensor 201 is individually provided for each of the four wheels 111, 112, 121, and 122, in FIG. 3, the wheel speed sensor 201 is schematically drawn as a single block. A signal indicating the rotation speed measured by the wheel speed sensor 201 is input to the vehicle control device 10. The vehicle control device 10 can grasp the traveling speed of the vehicle 100 on the basis of the signal.

The acceleration sensor 202 is a sensor for detecting the acceleration of the vehicle 100. The acceleration sensor 202 is attached to the vehicle body 101. The acceleration sensor 202 is configured as a six-axis acceleration sensor that can detect each rotation acceleration of pitching, rolling, and yawing in addition to each acceleration in the front-rear direction, the left-right direction, and the up-down direction of the vehicle body 101.

The acceleration acquired by the acceleration sensor 202 includes an acceleration GX along the advancing direction (that is, the front-rear direction) of the vehicle 100 and an acceleration Gy along the left-right direction of the vehicle 100. The acceleration GX is also referred to as “longitudinal acceleration”, and the acceleration Gy is also referred to as “lateral acceleration”. These are all acquired as numerical values in units of “G” that is the gravitational acceleration, and as exemplified as “0.5 G”. A signal indicating each acceleration detected by the acceleration sensor 202 is input to the vehicle control device 10.

The current sensor 203 is a sensor for detecting a value of a driving current flowing through the rotary electrical machine 150. A signal indicating the value of the driving current detected by the current sensor 203 is input to the vehicle control device 10. The vehicle control device 10 can determine the magnitude of the driving force generated in the rotary electrical machine 150 on the basis of the input value of the driving current.

The vehicle exterior camera 204 is a camera that captures an image around the vehicle 100, and is, for example, a complementary metal oxide semiconductor (CMOS) camera. Data of the image captured by the vehicle exterior camera 204 is input to the vehicle control device 10. The vehicle control device 10 can grasp the presence and the shape of an obstacle (for example, a level difference such as a wheel stop) around the vehicle 100 by processing the image.

As the sensor for detecting the condition around the vehicle 100, another sensor may be provided in addition to the vehicle exterior camera 204 or instead of the vehicle exterior camera 204. Examples of such a sensor include a LIDAR sensor, a radar, and the like.

The accelerator sensor 205 is a sensor that detects an operation amount of an accelerator pedal, that is, an accelerator opening degree. A signal indicating the operation amount of the accelerator pedal detected by the accelerator sensor 205 is input to the vehicle control device 10.

The external temperature sensor 206 is a sensor that detects the external temperature of the vehicle 100. A signal indicating the external temperature detected by the external temperature sensor 206 is input to the vehicle control device 10.

The gradient sensor 207 is a sensor that detects the gradient of the road surface on which the vehicle 100 is traveling. A signal indicating the gradient detected by the gradient sensor 207 is input to the vehicle control device 10.

The brake sensor 208 is a sensor that detects brake hydraulic pressure of the brake devices 131 and 132. A signal indicating the brake hydraulic pressure detected by the brake sensor 208 is input to the vehicle control device 10.

The parking sensor 209 is a sensor that detects on/off of a parking brake of the vehicle 100. A signal indicating the on/off detected by the parking sensor 209 is input to the vehicle control device 10.

The yaw rate sensor 210 is a sensor for detecting a yaw rate of the vehicle 100. A signal indicating the yaw rate detected by the yaw rate sensor 210 is input to the vehicle control device 10.

The rotation speed sensor 211 is a sensor for detecting the rotation angle and the rotation speed of the rotary electrical machine 150. A signal indicating the rotation speed detected by the rotation speed sensor 211 is input to the vehicle control device 10.

The cooling sensor 212 is a sensor for detecting the temperature of cooling water for cooling the drive device 152 including the rotary electrical machine 150 and the inverter 151. The cooling water cools, for example, the inverter 151. A signal indicating the temperature detected by the cooling sensor 212 is input to the vehicle control device 10.

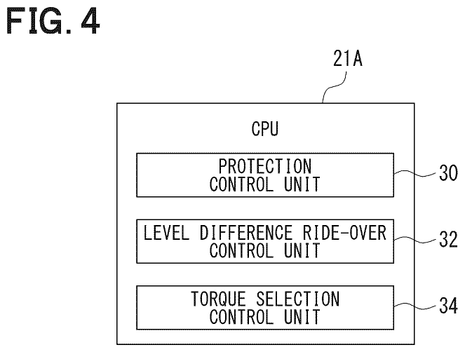

FIG. 4 is a block diagram illustrating a functional configuration of the CPU 21A of the vehicle control device 10. As illustrated in FIG. 4, the CPU 21A includes functional units, which are a protection control unit 30, a level difference ride-over control unit 32, and a torque selection control unit 34.

The protection control unit 30 executes protection control processing for protecting the drive device 152 by suppressing overheating of the drive device 152 including the rotary electrical machine 150 and the inverter 151.

The level difference ride-over control unit 32 executes level difference ride-over control processing for the vehicle 100 to ride over a level difference.

The torque selection control unit 34 executes torque selection control processing for selecting and controlling the torque of the rotary electrical machine 150.

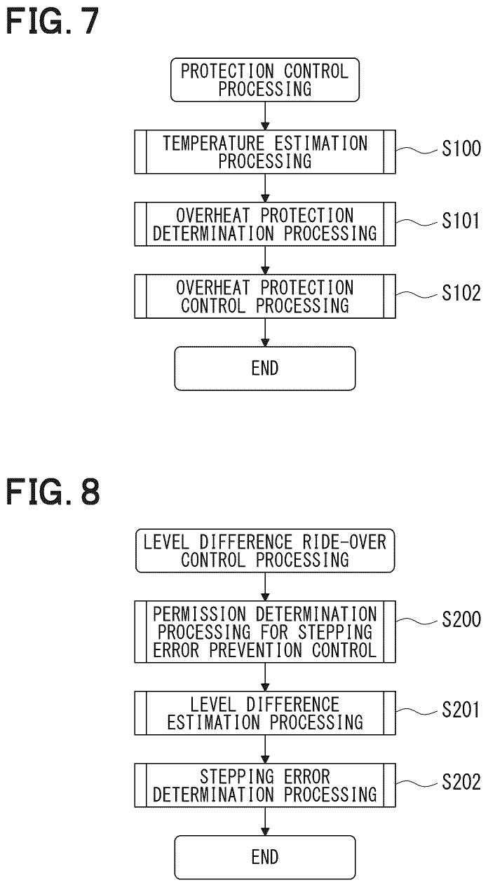

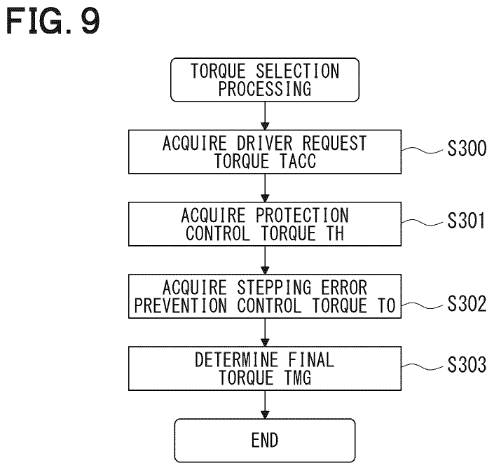

The CPU 21A functions as each of the functional units illustrated in FIG. 4 by reading and executing the vehicle control program 23A stored in the storage unit 23. The vehicle control program 23A executes processing including the protection control processing in FIG. 7, the level difference ride-over control processing in FIG. 8, and torque selection processing in FIG. 9, which are described later.

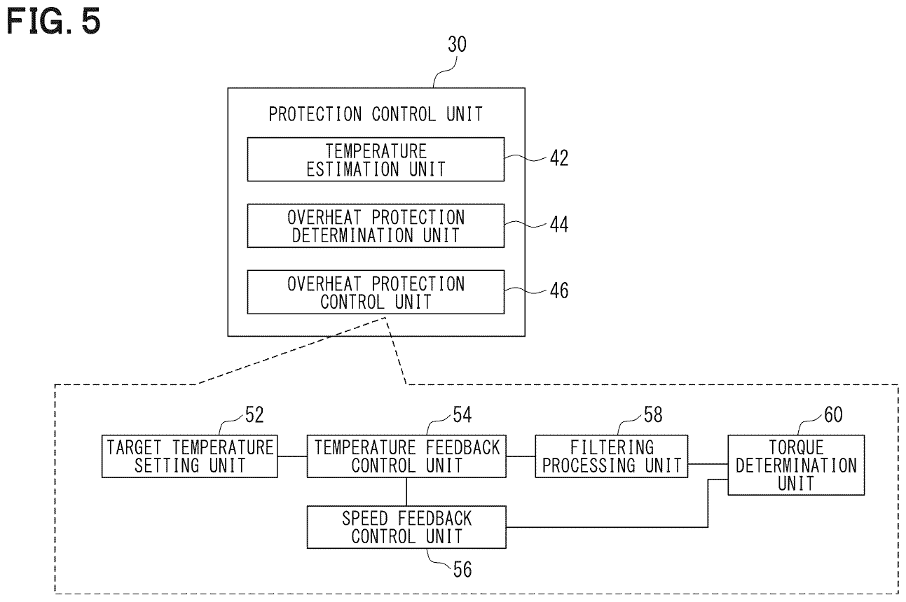

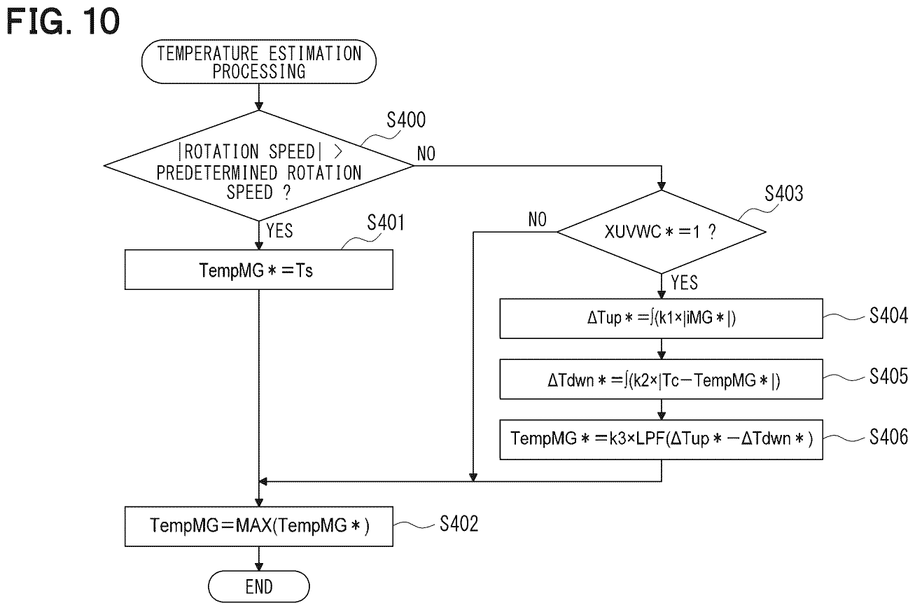

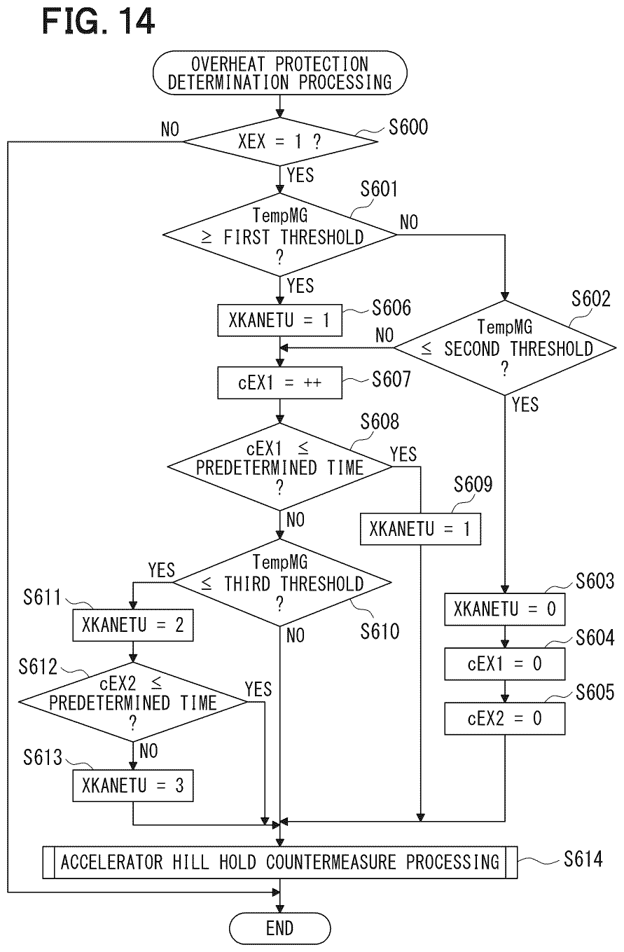

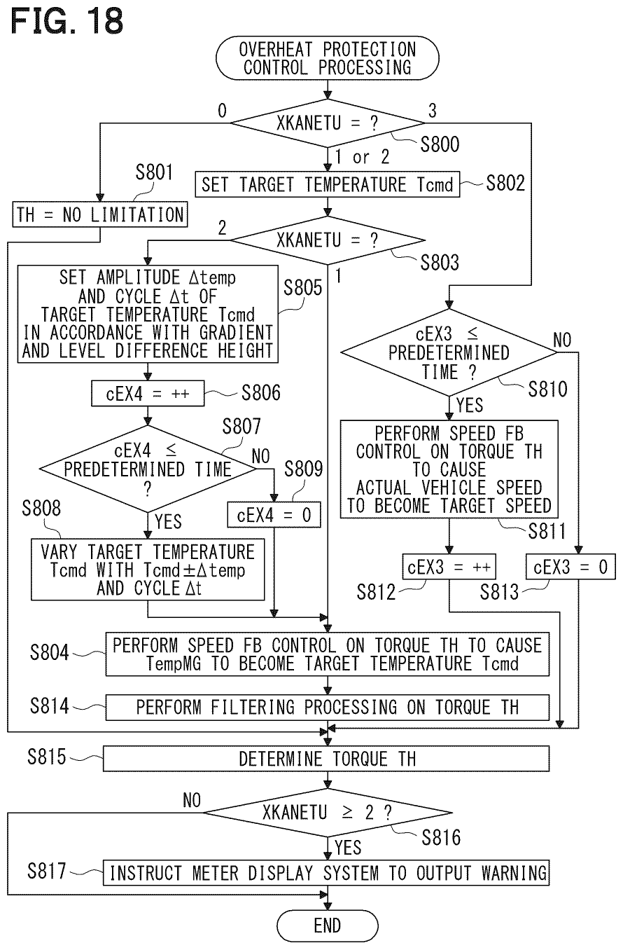

FIG. 5 is a block diagram illustrating functional units constituting the protection control unit 30 in more detail. As illustrated in FIG. 5, the protection control unit 30 includes functional units, which are a temperature estimation unit 42, an overheat protection determination unit 44, and an overheat protection control unit 46. The temperature estimation unit 42 executes temperature estimation processing illustrated in FIG. 10. The overheat protection determination unit 44 executes overheat protection determination processing illustrated in FIG. 14. The overheat protection control unit 46 executes overheat protection control processing illustrated in FIG. 18.

The overheat protection control unit 46 includes functional units, which are a target temperature setting unit 52, a temperature feedback control unit 54, a speed feedback control unit 56, a filtering processing unit 58, and a torque determination unit 60. The functions of the functional units constituting the protection control unit 30 will be described in protection control processing described later.

The temperature estimation unit 42 is an example of an “estimation unit” in the present disclosure, and a functional unit including the overheat protection determination unit 44 and the overheat protection control unit 46 is an example of a “control unit” in the present disclosure.

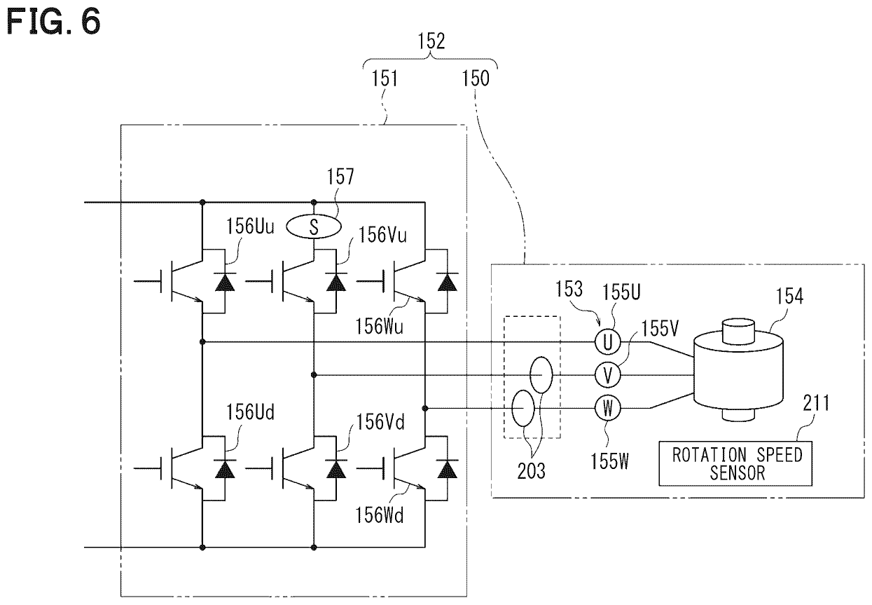

FIG. 6 is a circuit configuration diagram illustrating a configuration of the drive device 152 including the rotary electrical machine 150 and the inverter 151. The rotary electrical machine 150 includes a stator 153, a rotor 154, a current sensor 203, and a rotation speed sensor 211. The rotary electrical machine 150 is a three-phase motor generator, and the stator 153 has windings 155U, 155V, and 155W of a plurality of phases. The winding 155U is a U-phase winding, the winding 155V is a V-phase winding, and the winding 155W is a W-phase winding. As an example, the current sensor 203 detects a current flowing through the winding 155V and a current flowing through the winding 155W. The rotation speed sensor 211 is, for example, a resolver, and detects the rotation angle and the rotation speed of the rotor 154.

The inverter 151 includes six power elements 156Uu, 156Ud, 156Vu, 156Vd, 156Wu, and 156Wd. Hereinafter, in a case where it is not necessary to distinguish the six power elements 156Uu, 156Ud, 156Vu, 156Vd, 156Wu, and 156Wd from each other in description, the six power elements 156Uu, 156Ud, 156Vu, 156Vd, 156Wu, and 156Wd are each referred to as a “power element 156”. Each power element 156 is, for example, a power transistor. The power elements 156Uu and 156Ud are U-phase power elements, the power elements 156Vu and 156Vd are V-phase power elements, and the power elements 156Wu and 156Wd are W-phase power elements. The power elements 156Uu and 156Ud are bridge-connected to the winding 155U, the power elements 156Vu and 156Vd are bridge-connected to the winding 155V, and the power elements 156Wu and 156Wd are bridge-connected to the winding 155W.

The inverter 151 includes one temperature sensor 157. The temperature sensor 157 is provided in any one power element 156 among the plurality of power elements 156. In the present embodiment, as an example, the temperature sensor 157 is provided in the power element 156Vu and detects the temperature of the power element 156Vu. Here, an example in which the temperature sensor 157 is provided in the power element 156Vu is exemplified, but the temperature sensor may be provided in the power element 156 other than the power element 156Vu. The temperature sensor 157 may be provided in the power element 156 having the most severe heat resistance condition among the six power elements 156. For example, in a case where the inverter 151 has a heat dissipation mechanism, the power element 156 having the most severe heat resistance condition corresponds to a power element having the lowest heat dissipation energy by the heat dissipation mechanism.

Next, the protection control processing executed by the CPU 21A of the control unit 21, that is, the protection control processing for protecting the rotary electrical machine 150 by suppressing overheating of the rotary electrical machine 150 that drives the vehicle 100 will be described with reference to FIG. 7. The protection control processing illustrated in FIG. 7 is processing repeatedly executed every predetermined time, for example, every 10 msec.

In step S100, the CPU 21A (the temperature estimation unit 42) executes the temperature estimation processing illustrated in FIG. 10. Details of the temperature estimation processing will be described later.

In step S101, the CPU 21A (the overheat protection determination unit 44) executes the overheat protection determination processing illustrated in FIG. 14. Details of the overheat protection determination processing will be described later.

In step S102, the CPU 21A (the overheat protection control unit 46) executes the overheat protection control processing illustrated in FIG. 18. Details of the overheat protection control processing will be described later.

Next, level difference ride-over control processing executed by the CPU 21A of the control unit 21 will be described with reference to FIG. 8. The level difference ride-over control processing illustrated in FIG. 8 is processing repeatedly executed at predetermined time intervals, for example, every 10 msec.

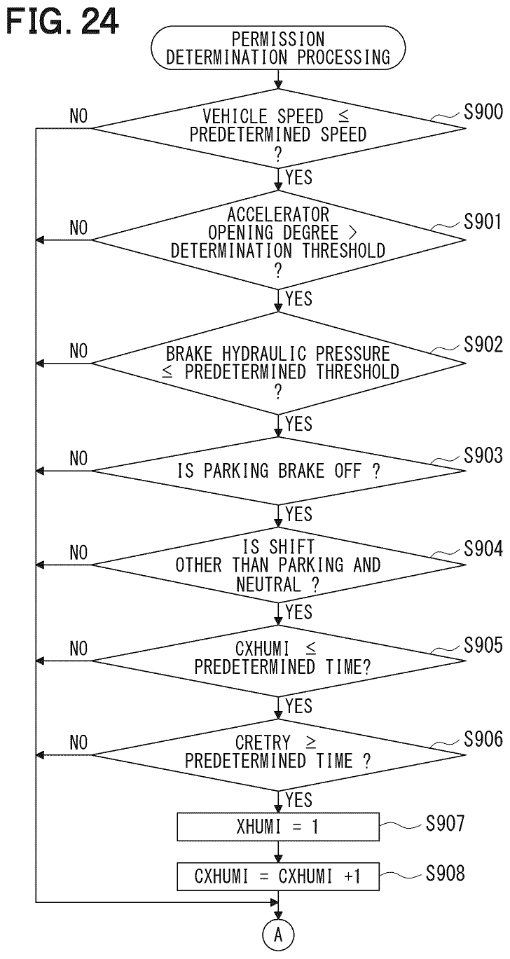

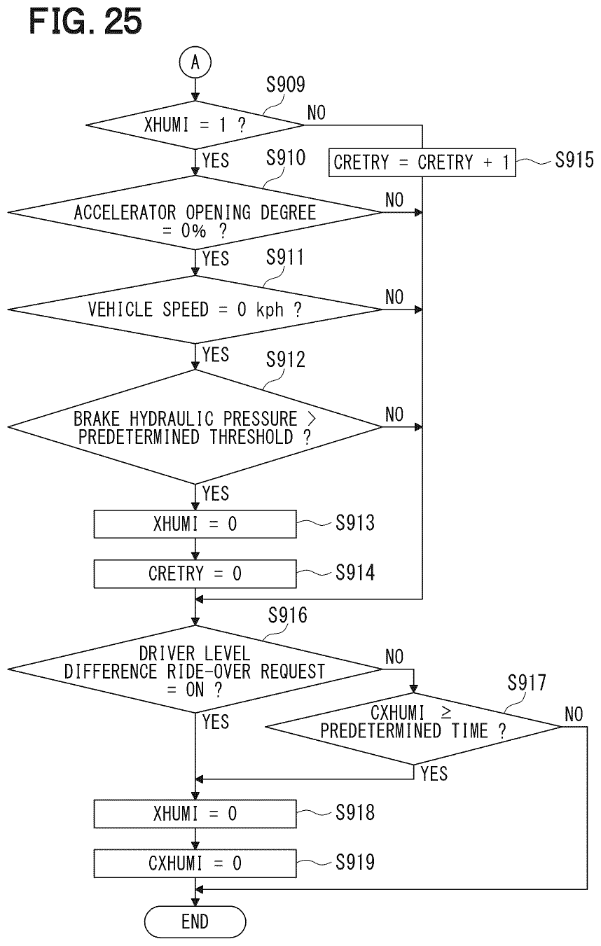

In step S200, the CPU 21A executes permission determination processing of stepping error prevention control illustrated in FIGS. 24 and 25. Details of the permission determination processing of the stepping error prevention control will be described later.

In step S201, the CPU 21A executes level difference estimation processing illustrated in FIG. 27. Details of the level difference estimation processing will be described later.

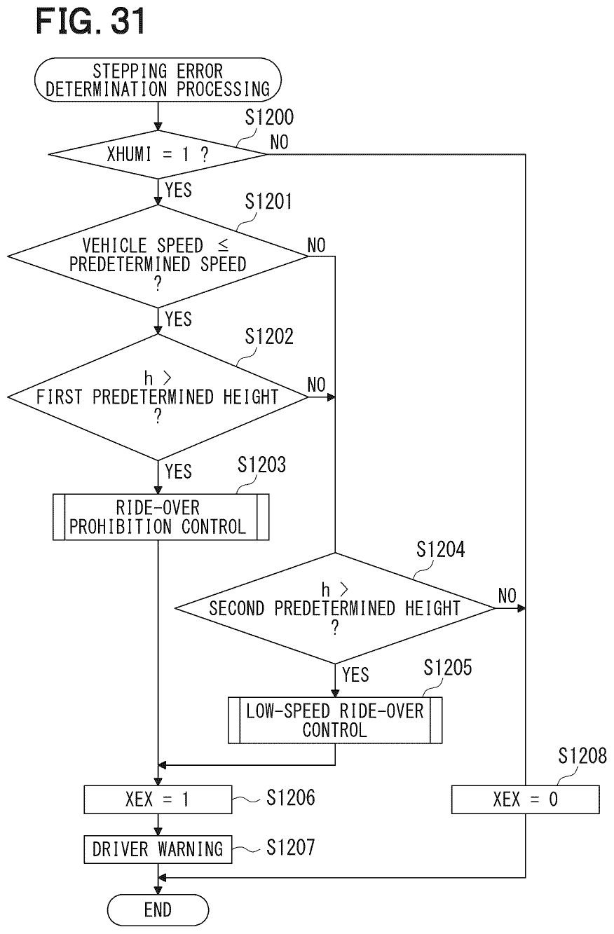

In step S202, the CPU 21A executes stepping error determination processing illustrated in FIG. 31. In the stepping error determination processing, a stepping error protection control torque TO to be applied to the rotary electrical machine 150 is calculated and stored in the storage unit 23. The stepping error prevention control torque TO stored in the storage unit 23 is sequentially updated every time level difference ride-over control is executed. Details of the stepping error determination processing will be described later.

Next, the torque selection processing executed by the CPU 21A of the control unit 21 will be described with reference to FIG. 9. The torque selection processing illustrated in FIG. 9 is processing repeatedly executed at predetermined time intervals, for example, every 10 msec.

In step S300, the CPU 21A reads a driver request torque TACC corresponding to the operation amount of the accelerator pedal of a driver of the vehicle 100 from the storage unit 23 to acquire the driver request torque TACC. The driver request torque TACC is a torque value corresponding to the operation amount of the accelerator pedal of the driver of the vehicle 100. For example, the torque map data 23B indicating a correspondence relationship between the operation amount of the accelerator pedal and the torque value is stored in the storage unit 23 in advance, a torque value corresponding to the operation amount of the accelerator pedal acquired from the accelerator sensor 205 is acquired from the torque map data 23B, and the torque map data 23B is stored in the storage unit 23 as the driver request torque TACC. The driver request torque TACC stored in the storage unit 23 is sequentially updated in accordance with the operation amount of the accelerator pedal of the driver.

In step S301, the CPU 21A reads a protection control torque TH calculated by the protection control processing illustrated in FIG. 7 from the storage unit 23 to acquire the protection control torque TH.

In step S302, the CPU 21A reads the stepping error prevention control torque TO calculated by the level difference ride-over control processing illustrated in FIG. 8 from the storage unit 23 to acquire the stepping error prevention control torque TO.

In step S303, the CPU 21A determines a final torque TMG to be applied to the rotary electrical machine 150. Specifically, the torque having the minimum torque value among the driver request torque TACC acquired in step S300, the overheat protection control torque TH acquired in step S301, and the stepping error prevention control torque TO acquired in step S302 is determined as the final torque TMG. With this configuration, an excessive torque can be prevented from being applied to the rotary electrical machine 150.

Next, details of the temperature estimation processing in step S100 in FIG. 7 will be described with reference to FIG. 10. The temperature estimation processing illustrated in FIG. 10 is processing repeatedly executed at predetermined time intervals, for example, every 10 msec. In the following description, “*” indicates a value for each of the six power elements 156, and in a case where “*” is excluded, the value indicates a value or a representative value of any of the six power elements 156.

In step S400, the CPU 21A determines whether the absolute value of the rotation speed of the rotary electrical machine 150 is larger than a predetermined rotation speed determined in advance on the basis of the detection result of the rotation speed sensor 211. The predetermined rotation speed is a rotation speed (that is, the rotation speed in the vicinity of the rotation stop) corresponding to a speed at which the vehicle 100 can be regarded as traveling at an extremely low speed. In the present embodiment, as an example, the predetermined rotation speed is set to 100 rpm, but is not limited thereto.

In a case where the absolute value of the rotation speed is larger than the predetermined rotation speed, the process proceeds to step S401, and in a case where the absolute value of the rotation speed is equal to or less than the predetermined rotation speed, the process proceeds to step S403.

In step S401, the CPU 21A estimates the temperature estimation value TempMG* (that is, six temperature estimation values each corresponding to each of the power elements 156) for every power element 156. Here, a temperature detection value Ts of the power element 156Vu detected by the temperature sensor 157 is set as the temperature estimation value TempMG* for every power element 156. As described above, the temperature sensor 157 is provided in the power element 156 having the most severe heat resistance condition. In a case where the absolute value of the rotation speed is larger than the predetermined rotation speed, because the thermal loads of the six power elements 156 become equal, the temperature detection value Ts of the power element 156Vu detected by the temperature sensor 157 can be regarded as the temperature estimation value TempMG* for every power element 156.

In step S402, the CPU 21A selects the highest temperature estimation value TempMG among the temperature estimation values TempMG* of the respective power elements 156.

In step S403, the CPU 21A determines whether the single-phase continuous energization flag XUVWC* for every power element 156 (that is, six single-phase continuous energization flags each corresponding to each of the power elements 156) is 1. Although details of the single-phase continuous energization flag XUVWC* will be described later, in a case where the single-phase continuous energization flag XUVWC* is 1, it indicates that continuous energization is being performed in any of the U phase, the V phase, and the W phase of the rotary electrical machine 150 that is a three-phase motor generator, that is, the phase is not changed, and the rotary electrical machine 150 is stopped. In other words, in a case where the single-phase continuous energization flag XUVWC* is 1, it indicates that, as a result of the drive device 152 becoming an overloaded state and the vehicle 100 being stopped, the drive device 152 is in the single-phase continuous energization state in which the current continuously flows through any one of the plurality of phases. On the other hand, in a case where the single-phase continuous energization flag XUVWC* is 0, the energization phase is being changed from any one of the U phase, the V phase, and the W phase to another phase, that is, the rotary electrical machine 150 is rotating.

In a case where the single-phase continuous energization flag XUVWC* is 1, the process proceeds to step S404, and in a case where the single-phase continuous energization flag XUVWC* is 0, the process proceeds to step S402.

In step S404, the CPU 21A calculates ΔTup* indicating an amount of temperature rise caused by the heat generation of the drive device 152. ΔTup* can be calculated by the following formula.

$$Δ {Tup}^{⋆} = \int ( k 1 \times \vert iM {G}^{⋆} \vert ) \qquad ( 1 )$$

Here, iMG* is a current value (that is, six current values each corresponding to each of the power elements 156) for every power element 156, and can be acquired on the basis of the current value detected by the current sensor 203. k1 is a predetermined coefficient for converting the current value iMG* into temperature, and is set in advance as a value suitable for calculating ΔTup in a case where the absolute value of the rotation speed is equal to or less than a predetermined rotation speed. In this case, the rotation speed may be set to a fixed value of 0 rpm. As in the above formula, ΔTup* is calculated by integration processing of the amount of heat generation by the current value. ΔTup* corresponds to the heat generation energy estimated on the basis of the current value iMG* for every power element 156. ΔTup* is calculated for every power element 156.

In step S405, the CPU 21A calculates ΔTdwn* indicating an amount of temperature drop due to heat dissipation of the drive device 152 by heat exchange with the outside. ΔTdwn* can be calculated by, for example, a predetermined calculation formula including the external temperature of the vehicle 100 as a parameter. The external temperature may be acquired from the external temperature sensor 206. ΔTdwn* can be calculated by the following formula.

$$Δ {Tdwn}^{⋆} = \int ( k 2 \times \vert Tc - {TempMG}^{⋆} \vert ) \qquad ( 2 )$$

Here, Tc is a temperature of cooling water for cooling the drive device 152 (as an example, the inverter 151), and can be detected by a water temperature sensor (not illustrated). The temperature of the cooling water may be a fixed value as the maximum temperature (for example, 65° C.) of the cooling capacity limit. Because the maximum temperature is the temperature in respect of being able to protect the components, the temperature of the cooling water may be a fixed value of the maximum temperature of the cooling capacity limit. k2 is a predetermined coefficient for calculating ΔTdwn*, and is set in advance as a value suitable for calculating ΔTdwn* in a case where the absolute value of the rotation speed is equal to or less than a predetermined rotation speed. As in the above formula, ΔTdwn* is calculated by integration processing of the amount of heat dissipation by heat exchange with the cooling water. ΔTdwn* corresponds to heat dissipation energy estimated on the basis of the temperature detection value Ts and the temperature of the cooling water for cooling the inverter 151. ΔTdwn* is calculated for every power element 156. By considering the heat dissipation energy, the temperature of the drive device 152 can be accurately estimated.

In step S406, the CPU 21A calculates the temperature estimation value TempMG* for every power element 156. TempMG* can be calculated by the following formula.

$$T e m p M {G}^{⋆} = k 3 \times L P F ( Δ T u {p}^{⋆} - Δ T d w {n}^{⋆} ) \qquad ( 3 )$$

Here, k3 is a predetermined coefficient for calculating TempMG*, and is set in advance as a value suitable for calculating TempMG* in a case where the absolute value of the rotation speed is equal to or less than a predetermined rotation speed. LPF( ) is a function indicating a low-pass filter. As in the above formula, TempMG* is calculated on the basis of the idea that the energy of the amount of heat generation and the energy of the amount of heat dissipation are proportional to the temperature. The time constant of the low-pass filter may be changed between a case where the temperature is rising and in a case where the temperature is falling. TempMG* is calculated for every power element 156.

As described above, in the temperature estimation processing, the temperature of the drive device 152 is estimated on the basis of the temperature detection value of the power element 156 and the current value for every power element 156. Therefore, whether the drive device 152 is overheated can be accurately determined. With this configuration, in the overheat protection control processing described later, control for lowering the temperature of the drive device 152 can be performed at an appropriate timing.

Because the temperature sensor 157 is provided in one power element 156 among the six power elements 156, the cost can be reduced as compared with a case where the temperature sensors 157 are provided in all the six power elements 156.

In the present embodiment, the temperature sensor 157 is provided only in one power element 156 among the six power elements 156. However, the temperature sensors 157 may be provided in a plurality of power elements 156 among the six power elements 156, or the temperature sensors 157 may be provided in all the six power elements 156. Furthermore, for example, in a case where the temperature sensor 157 is provided in all of the six power elements 156, the temperature of the drive device 152 may be estimated on the basis of the temperature detection value detected by each of the temperature sensors 157, and the temperature feedback control described later may be executed on the basis of the estimated temperature.

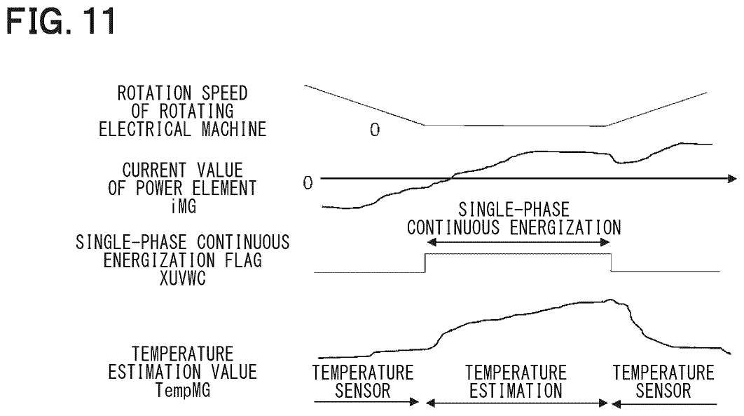

FIG. 11 illustrates a relationship among the rotation speed of the rotary electrical machine 150, the current value iMG of the power element 156, the single-phase continuous energization flag XUVWC, and the temperature estimation value TempMG of the power element 156. FIG. 11 illustrates one current value iMG among the current values iMG* of the respective power elements 156, one single-phase continuous energization flag XUVWC among the single-phase continuous energization flags XUVWC* of the respective power elements 156, and one temperature estimation value TempMG among the temperature estimation values TempMG* of the respective power elements 156.

As described above, in the temperature estimation processing, in a case where the absolute value of the rotation speed of the rotary electrical machine 150 is larger than the predetermined rotation speed (that is, the number of rotations in the vicinity of the rotation stop), the temperature estimation value TempMG* for every power element 156 is estimated on the basis of the temperature detection value Ts of the temperature sensor 157. With this configuration, for example, the load on the CPU 21A can be reduced as compared with a case where the temperature estimation value TempMG* for every power element 156 is estimated on the basis of the temperature detection value Ts and the current value iMG* for every power element 156. On the other hand, in a case where the absolute value of the rotation speed of the rotary electrical machine 150 is equal to or less than the predetermined rotation speed, the temperature estimation value TempMG* for every power element 156 is estimated on the basis of the temperature detection value Ts and the current value iMG* for every power element 156. With this configuration, the temperature estimation value TempMG* for every power element 156 can be accurately estimated as compared with a case where the temperature estimation value TempMG* for every power element 156 is estimated only on the basis of the temperature detection value Ts of the temperature sensor 157.

In a case where the single-phase continuous energization state is established as a result of the drive device 152 becoming an overloaded state and the vehicle 100 being stopped, the thermal load of the phase in which the current concentrates is increased to three times as compared with a case where the thermal load is not overloaded. Therefore, in a case where the single-phase continuous energization state is established, by estimating the temperature estimation value TempMG* for every power element 156 on the basis of the temperature detection value Ts and the current value iMG* for every power element 156, the temperature estimation value TempMG* can be accurately estimated.

Then, the highest temperature estimation value TempMG is selected from among the temperature estimation values TempMG* of the respective power elements 156. With this configuration, for example, as compared with a case where the lowest temperature estimation value TempMG is selected from among the temperature estimation values TempMG* of the respective power elements 156, the occurrence of failure due to overheating of the drive device 152 can be suppressed. The temperature estimation value TempMG can be estimated as the temperature of the drive device 152. The temperature of the drive device 152 may be the temperature of the rotary electrical machine 150 or may be the temperature of the inverter 151. The temperature of the drive device 152 may be the temperature of the rotary electrical machine 150 and the inverter 151. The overheat protection determination processing illustrated in FIG. 14 and the overheat protection control processing illustrated in FIG. 18 are executed on the basis of the temperature estimation value TempMG.

In the temperature estimation processing according to the present embodiment, in step S403, it is determined whether the single-phase continuous energization flag XUVWC* for every power element 156 is 1. However, the determination in step S403 may be omitted. In a case where the determination in step S403 is omitted, the temperature estimation processing may be the following processing.

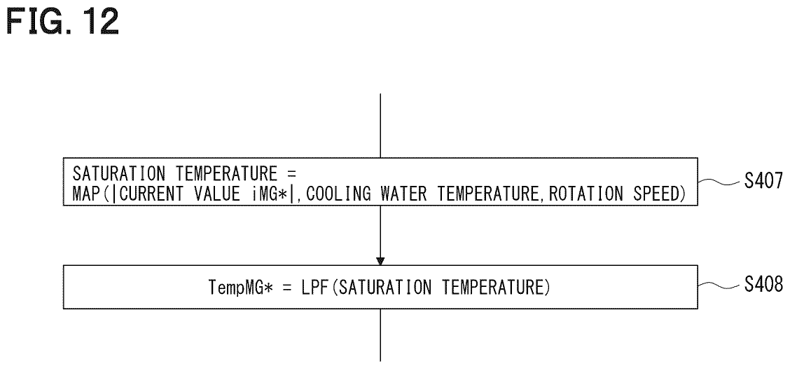

FIG. 12 illustrates a modification of a part of the temperature estimation processing. In the present modification, steps S407 to S408 are executed instead of steps S404 to S406 of the temperature estimation processing illustrated in FIG. 10.

In step S407, the CPU 21A derives the saturation temperature for every power element 156. The saturation temperature is extracted from a map defining the relationship among the saturation temperature, the absolute value of the current value iMG* for every power element 156, the temperature of the cooling water, and the rotation speed of the rotary electrical machine 150. The temperature of the cooling water may be a fixed value as the maximum temperature (for example, 65° C.) of the cooling capacity limit. The rotation speed of the rotary electrical machine 150 may be set to 0 rpm as a fixed value.

In step S408, the CPU 21A calculates the temperature estimation value TempMG* for every power element 156 on the basis of the saturation temperature for every power element 156 by using a function indicating the low-pass filter.

In this way, the temperature estimation value TempMG* for every power element 156 can be calculated regardless of whether the power element is in the single-phase continuous energization state. In other words, even in a state where the rotation speed of the rotary electrical machine 150 is, for example, 100 rpm or less and the rotation of the rotary electrical machine 150 is not completely stopped, the temperature estimation value TempMG* for every power element 156 can be calculated.

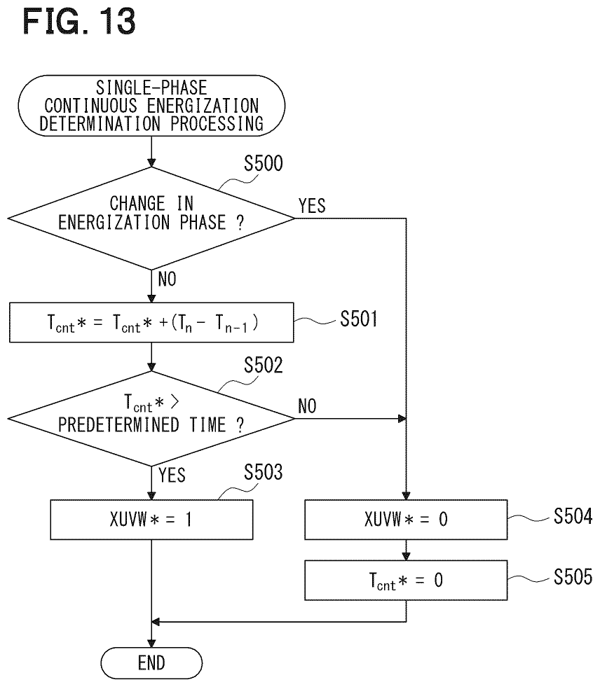

Next, The single-phase continuous energization determination processing will be described with reference to FIG. 13. Note that the single-phase continuous energization determination processing illustrated in FIG. 13 may be executed by the inverter 151.

In step S500, the CPU 21A determines whether the energization phase has changed. That is, it is determined whether any energized phase among the U phase, the V phase, and the W phase has changed to another phase. In a case where the energization phase has not changed, the process proceeds to step S501, and in a case where the energization phase has changed, the process proceeds to step S504.

In step S501, the CPU 21A updates a counter T_{cnt}* indicating the single-phase continuous energization time for every power element 156 by the following formula.

$${T}_{cnt}^{*} = {T}_{cnt}^{*} + ( {t}_{n} - {t}_{n - 1} ) \qquad ( 4 )$$

Here, tₙ is the time when the processing in FIG. 12 has been executed this time, and tₙ₋₁ is the time when the processing in FIG. 9 has been executed last time. The counter T_{cnt}* is reset in step S505 described later.

In step S502, the CPU 21A determines whether the counter T_{cnt}* is longer than a predetermined time, that is, whether a predetermined time has elapsed since the counter T_{cnt}* was reset. In the present embodiment, as an example, the predetermined time is set to 0.5 seconds, but is not limited thereto. In a case where the counter T_{cnt}* is longer than the predetermined time, the process proceeds to step S503, and in a case where the counter T_{cnt}* is equal to or less than the predetermined time, the process proceeds to step S504.

In step S503, the CPU 21A sets the single-phase continuous energization flag XUVWC* for every power element 156 to 1.

In step S504, the CPU 21A sets the single-phase continuous energization flag XUVWC* for every power element 156 to 0.

In step S505, the CPU 21A sets the counter T_{cnt}* to 0. That is, the counter T_{cnt}* is reset.

Next, details of the overheat protection determination processing in step S101 in FIG. 7 will be described with reference to FIG. 14. The overheat protection determination processing illustrated in FIG. 14 is processing repeatedly executed at predetermined time intervals, for example, every 10 msec.

In step S600, the CPU 21A determines whether a level difference ride-over control flag XEX is 1. In a case where the level difference ride-over control flag XEX is 1, it indicates that the level difference ride-over control described later is being executed, and in a case where the level difference ride-over control flag XEX is 0, it indicates that the level difference ride-over control is not being executed. Setting of the level difference ride-over control flag will be described later.

In a case where the level difference ride-over control flag XEX is 1, that is, in a case where the level difference ride-over control is being executed, the process proceeds to step S601. On the other hand, in a case where the level difference ride-over control flag XEX is 0, that is, in a case where the level difference ride-over control is not being executed, this routine is ended.

In step S601, the CPU 21A determines whether the temperature TempMG estimated in the temperature estimation processing in FIG. 10 is equal to or more than a first threshold. The first threshold is essentially a temperature at which the overheat protection control processing needs to be performed, and is set to 165° C. as an example in the present embodiment, but is not limited thereto. Then, in a case where TempMG is less than the first threshold, the process proceeds to step S602, and in a case where TempMG is equal to or more than the first threshold, the process proceeds to step S606.

In step S602, the CPU 21A determines whether the temperature TempMG estimated in the temperature estimation processing in FIG. 10 is equal to or less than a second threshold. The second threshold is a temperature set to a target temperature in a case where temperature feedback control is performed in the overheat protection control processing, and is set to a value lower than the first threshold. In the present embodiment, as an example, the second threshold is set to 140° C., but is not limited thereto. Then, in a case where TempMG is equal to or less than the second threshold, the process proceeds to step S603, and in a case where TempMG exceeds the second threshold, the process proceeds to step S607.

In step S603, the CPU 21A sets an overheat protection mode flag XKANETU to 0. The overheat protection mode flag XKANETU is a flag indicating an overheat protection mode in the overheat protection control processing illustrated in FIG. 18. The overheat protection mode will be described later.

In step S604, the CPU 21A sets a first torque limitation execution counter cEX1 to 0.

In step S605, the CPU 21A sets a second torque limitation execution counter cEX2 to 0.

In step S606, the CPU 21A sets the overheat protection mode flag XKANETU to 1.

In step S607, the CPU 21A increments the first torque limitation execution counter cEX1.

In step S608, the CPU 21A determines whether the first torque limitation execution counter cEX1 is equal to or less than a predetermined time. In the present embodiment, as an example, the predetermined time is set to 5 seconds, but is not limited thereto. Then, in a case where the first torque limitation execution counter cEX1 is equal to or less than the predetermined time, the process proceeds to step S609, and in a case where the first torque limitation execution counter cEX1 exceeds the predetermined time, the process proceeds to step S610.

In step S609, the CPU 21A sets the overheat protection mode flag XKANETU to 1.

In step S610, the CPU 21A determines whether the temperature TempMG estimated in the temperature estimation processing in FIG. 10 is equal to or less than a third threshold. The third threshold is set to a temperature between the first threshold and the second threshold. In the present embodiment, as an example, the third threshold is set to 150° C., but is not limited thereto. Then, in a case where TempMG is equal to or less than the third threshold, the process proceeds to step S611, and in a case where TempMG exceeds the third threshold, the process proceeds to step S614.

In step S611, the CPU 21A sets the overheat protection mode flag XKANETU to 2.

In step S612, the CPU 21A determines whether the second torque limitation execution counter cEX2 is equal to or less than a predetermined time. In the present embodiment, as an example, the predetermined time is set to 10 seconds, but is not limited thereto. Then, in a case where the second torque limitation execution counter cEX2 is equal to or less than the predetermined time, the process proceeds to step S614, and in a case where the second torque limitation execution counter cEX2 exceeds the predetermined time, the process proceeds to step S613.

In step S613, the CPU 21A sets the overheat protection mode flag XKANETU to 3.

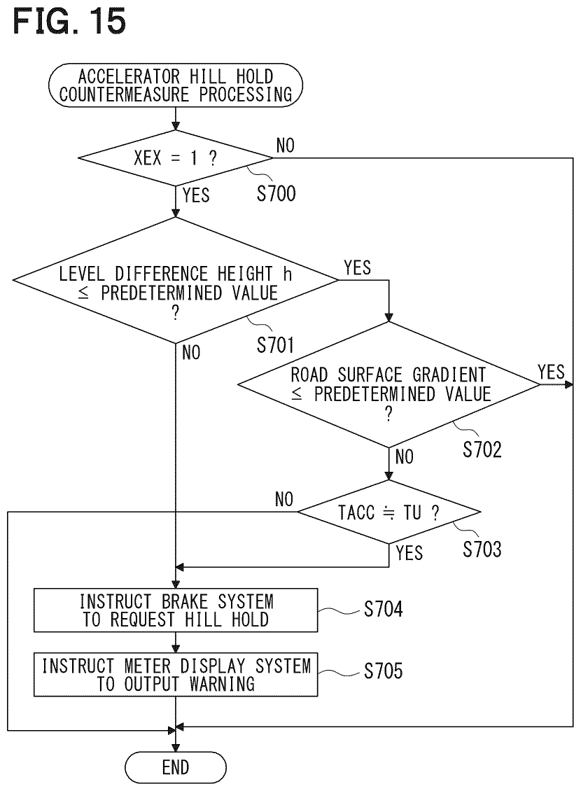

In step S614, the CPU 21A executes accelerator hill hold countermeasure processing illustrated in FIG. 15.

Next, details of the accelerator hill hold countermeasure processing in step S614 in FIG. 14 will be described with reference to FIG. 15. The accelerator hill hold means that in a case where the vehicle 100 rides over a level difference or travels on an uphill road, the vehicle 100 is kept stopped by an operation of an accelerator pedal provided in the vehicle 100.

In step S700, the CPU 21A determines whether the level difference ride-over control flag XEX is 1. In a case where the level difference ride-over control flag XEX is 1, it indicates that the level difference ride-over control described later is being executed. In other words, in a case where the level difference ride-over control flag XEX is 1, it indicates that the vehicle 100 is in a stopped state due to the load torque acting on the rotary electrical machine 150 balancing with the torque of the rotary electrical machine 150 at the time when the vehicle 100 rides over a level difference or travels on an uphill road. In a case where the level difference ride-over control flag XEX is 0, it indicates that the level difference ride-over control described later is not being executed. Setting of the level difference ride-over control flag XEX will be described later.

In a case where the level difference ride-over control flag XEX is 1, that is, in a case where the level difference ride-over control is being executed, the process proceeds to step S701. On the other hand, in a case where the level difference ride-over control flag XEX is 0, that is, in a case where the level difference ride-over control is not being executed, this routine is ended.

In step S701, the CPU 21A determines whether a level difference height h estimated in the level difference estimation processing estimation in FIG. 27 is equal to or less than a predetermined value. The estimation of the level difference height h in the level difference estimation processing will be described later. Then, in a case where the level difference height h is equal to or less than a predetermined value, the process proceeds to step S702. On the other hand, in a case where the level difference height h exceeds the predetermined value, the process proceeds to step S704.

In step S702, the CPU 21A determines whether the gradient of the road surface detected by the gradient sensor 207 is equal to or less than a predetermined value. In a case where the gradient exceeds a predetermined value, the process proceeds to step S703. On the other hand, in a case where the gradient is equal to or less than the predetermined value, this routine is ended.

In step S703, the CPU 21A determines whether the driver request torque TACC is substantially equal to a gradient torque TU. Details of the driver request torque TACC will be described in the description of the torque selection processing. Details of the gradient torque TU will be described in the description of the stepping error determination processing in FIG. 31.

In a case where the driver request torque TACC is substantially equal to the gradient torque TU, the process proceeds to step S704. On the other hand, in a case where the driver request torque TACC is not substantially equal to the gradient torque TU, this routine is ended.

In step S704, the CPU 21A outputs an instruction to request the hill hold (that is, an instruction to stop the vehicle 100 by operating the brake instead of operating the accelerator pedal) to the brake ECU 20 that controls the brake devices 131 and 132. The brake ECU 20 is an example of a “brake control device” in the present disclosure.

In step S705, the CPU 21A outputs an instruction to output a warning to a meter display system. The warning in this case is a warning to the driver of the vehicle 100, and is, for example, a message “Please release the accelerator and stop by braking”. The warning may be given by voice or text messages. The warning may be output to a system other than the meter display system.

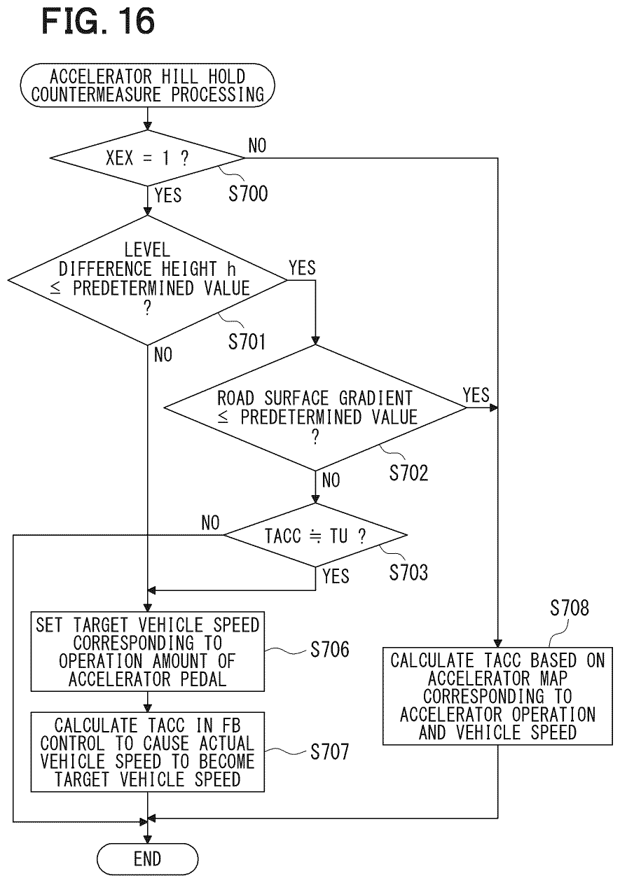

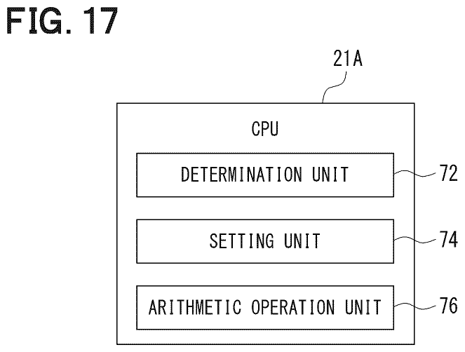

FIG. 16 illustrates a modification of the accelerator hill hold countermeasure processing. In the accelerator hill hold countermeasure processing according to the present modification, steps S706 to S708 are executed instead of steps S704 to S705 of the accelerator hill hold response processing illustrated in FIG. 15. FIG. 17 illustrates a configuration of functional units for executing the accelerator hill hold countermeasure processing according to the present modification. In the present modification, the CPU 21A functions as a determination unit 72, a setting unit 74, and an arithmetic operation unit 76. The determination unit 72 executes determination processing in steps S700 to S703. The setting unit 74 executes setting processing in step S706. The arithmetic operation unit 76 executes arithmetic processing in steps S707 to S708.

The determination processing in steps S700 to S703 is similar to the determination processing in steps S700 to S703 in the accelerator hill hold countermeasure processing illustrated in FIG. 15.

In step S706, the CPU 21A (setting unit 74) sets a target speed of the vehicle 100 in accordance with the operation amount of the accelerator pedal detected by the accelerator sensor. For example, the CPU 21A sets a target speed proportional to the operation amount of the accelerator pedal.

In step S707, the CPU 21A (arithmetic operation unit 76) arithmetically operates the driver request torque TACC (that is, the target torque of the rotary electrical machine 150) at the time when the feedback control is performed to cause the actual vehicle speed of the vehicle 100 to become the target speed.

In step S708, the CPU 21A (arithmetic operation unit 76) arithmetically operates (derives) the driver request torque TACC corresponding to the operation amount of the accelerator pedal and the vehicle speed in accordance with an accelerator map defining the relationship among the operation amount of the accelerator pedal, the vehicle speed, and the driver request torque TACC.

According to the present modification, in a case where the vehicle 100 rides over a level difference or travels on an uphill road, even in a state where the vehicle 100 is stopped due to the load torque acting on the rotary electrical machine 150 balancing with the torque of the rotary electrical machine 150, the target speed is set in accordance with the operation amount of the accelerator pedal, and the feedback control is performed to cause the actual vehicle speed of the vehicle 100 to become the target speed. Therefore, the vehicle 100 can ride over the level difference or climb the uphill road.

Next, details of the overheat protection control processing in step S101 in FIG. 7 will be described with reference to FIG. 18. The overheat protection control processing illustrated in FIG. 18 is processing repeatedly executed at predetermined time intervals, for example, every 10 msec.

In step S800, the CPU 21A determines whether the overheat protection mode flag XKANETU is any of 0 to 3. In a case where the overheat protection mode flag XKANETU is 0, the process proceeds to step S801, in a case where the overheat protection mode flag XKANETU is 1 or 2, the process proceeds to step S802, and in a case where the overheat protection mode flag XKANETU is 3, the process proceeds to step S810.

In step S801, the CPU 21A sets the overheat protection control torque TH without limitation. That is, the limitation of the overheat protection control torque TH is released, and the overheat protection control torque TH is not selected as the minimum torque.

In step S802, the CPU 21A (that is, the target temperature setting unit 52) sets a target temperature Tcmd. In the present embodiment, as an example, the target temperature Tcmd is set to 140° C., but is not limited thereto.

In step S803, the CPU 21A determines whether the overheat protection mode flag XKANETU is 1 or 2. In a case where the overheat protection mode flag XKANETU is 1, the process proceeds to step S804, and in a case where the overheat protection mode flag XKANETU is 2, the process proceeds to step S805.

In step S804, the CPU 21A (that is, the temperature feedback control unit 54) controls (that is, temperature feedback controls) the overheat protection control torque TH on the basis of the temperature estimation value TempMG to cause the temperature estimation value TempMG to become the target temperature Tcmd.

In step S805, the CPU 21A (that is, the target temperature setting unit 52) sets an amplitude Δtemp and a cycle Δt of the target temperature Tcmd in accordance with the gradient detected by the gradient sensor and the level difference height h estimated in the level difference estimation processing.

In step S806, the CPU 21A increments a variation control execution counter cEX4. The variation control execution counter cEX4 is a counter for periodically varying the target temperature.

In step S807, the CPU 21A determines whether the variation control execution counter cEX4 is equal to or less than a predetermined time. In the present embodiment, as an example, the predetermined time is set to 5 seconds, but is not limited thereto. Then, in a case where the variation control execution counter cEX4 is equal to or less than the predetermined time, the process proceeds to step S808, and in a case where the variation control execution counter cEX4 exceeds the predetermined time, the process proceeds to step S809.

In step S808, the CPU 21A (that is, the target temperature setting unit 52) varies the target temperature Tcmd with the amplitude Δtemp and the cycle Δt.

In step S809, the CPU 21A sets the variation control execution counter cEX4 to 0.

In step S810, the CPU 21A determines whether a speed feedback execution counter cEX3 is equal to or less than a predetermined time. In the present embodiment, as an example, the predetermined time is set to 5 seconds, but is not limited thereto. Then, in a case where the speed feedback execution counter cEX3 is equal to or less than the predetermined time, the process proceeds to step S811, and in a case where the speed feedback execution counter cEX3 exceeds the predetermined time, the process proceeds to step S813.

In step S811, the CPU 21A (that is, the speed feedback control unit 56) controls (that is, speed feedback controls) the overheat protection control torque TH on the basis of the actual vehicle speed to cause the actual vehicle speed calculated from the wheel speed sensor to become a predetermined target speed. The target speed is a speed in an extremely low speed range, and is set to 0.5 kph to 1 kph as an example in the present embodiment, but is not limited thereto.

In step S812, the CPU 21A increments the speed feedback execution counter cEX3.

In step S813, the CPU 21A sets the speed feedback execution counter cEX3 to 0.

In step S814, the CPU 21A (that is, the filtering processing unit 58) performs filtering processing on the overheat protection control torque TH (that is, the target torque) controlled in step S804. Details of the filtering processing will be described later. The filtering processing may be executed by a dedicated filter circuit.

In step S815, the CPU 21A (that is, the torque determination unit 60) determines the overheat protection control torque TH. Specifically, a torque having the minimum torque value among the overheat protection control torque TH set in step S801, the overheat protection control torque TH set in step S804, and the overheat protection control torque TH set in step S811 is determined as the overheat protection control torque TH. The overheat protection control torque TH may be executed by a dedicated arithmetic circuit.

In step S816, the CPU 21A determines whether the overheat protection mode flag XKANETU is equal to or more than 2. In a case where the overheat protection mode flag XKANETU is equal to or more than 2, the process proceeds to step S817, and in a case where the overheat protection mode flag XKANETU is equal to or less than 1, this routine is ended.

In step S817, the CPU 21A outputs an instruction to output a warning to a meter display system. The warning in this case is a warning to the driver of the vehicle 100, and is, for example, a message “Please release the accelerator and stop by braking”. The warning may be given by voice or text messages. The warning may be output to a system other than the meter display system.

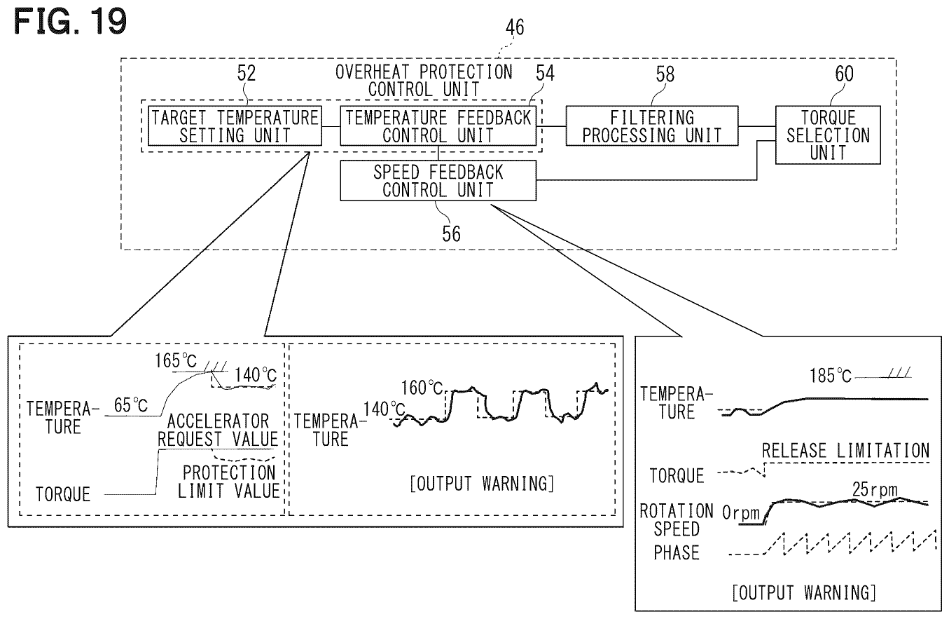

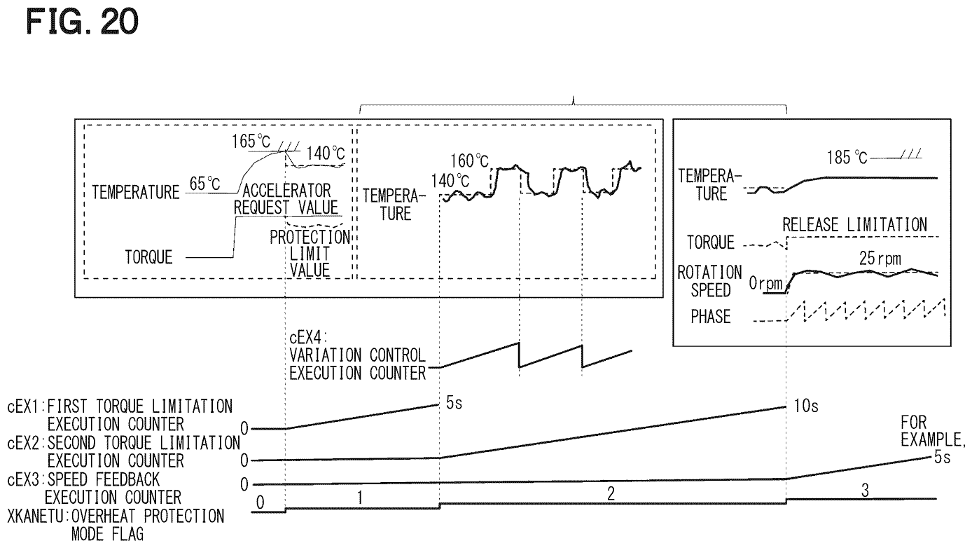

FIGS. 19 and 20 illustrate operation examples of the target temperature setting unit 52, the temperature feedback control unit 54, and the speed feedback control unit 56. The overheat protection control processing illustrated in FIG. 18 will be described in more detail on the basis of the present operation example.

In a case where the vehicle 100 rides over a level difference or travels on an uphill road, if a state in which the vehicle 100 stops continues due to the load torque acting on the rotary electrical machine 150 balancing with the torque of the rotary electrical machine 150 (that is, the accelerator request value), the drive device 152 becomes an overloaded state, and thus, the temperature TempMG estimated in the temperature estimation processing rises from the temperature during normal traveling (for example, 65° C.).

When the temperature TempMG estimated by the temperature estimation processing becomes equal to or more than a predetermined first threshold (for example, 165° C.), the overheat protection mode flag XKANETU is set to 1. Then, the target temperature setting unit 52 sets the target temperature Tcmd lower than the first threshold (for example, 140° C.). The target temperature may be set on the basis of the rotation speed of the rotary electrical machine 150 detected by the rotation speed sensor 211, the current value of the rotary electrical machine 150 detected by the current sensor 203, and the temperature of the power element 156Vu detected by the temperature sensor 157.

The temperature feedback control unit 54 controls (that is, temperature feedback controls) the overheat protection control torque TH on the basis of the temperature estimation value TempMG to cause the temperature estimation value TempMG to become the target temperature Tcmd. With this configuration, the overheat protection control torque TH is controlled to cause the temperature of the drive device 152 to decrease (that is, the temperature of the drive device 152 be set to the target temperature Tcmd). That is, the overheat protection control torque TH is limited to a protection limit value corresponding to the target temperature Tcmd. By executing the temperature feedback control to limit the overheat protection control torque TH in this manner, the temperature of the drive device 152 can be lowered.

Routine processing proceeds after the temperature feedback control is started, and in a case where the vehicle 100 remains stopped even when the first torque limitation execution counter cEX1 becomes equal to or more than a predetermined time (that is, even when the predetermined first time has elapsed), the overheat protection mode flag XKANETU is set to 2. The target temperature setting unit 52 periodically varies the target temperature Tcmd. In a case of periodically varying the target temperature Tcmd, the target temperature setting unit 52 varies the amplitude Δtemp and the cycle Δt of the target temperature on the basis of the variation control execution counter cEX4 in accordance with the level difference height h that the vehicle 100 is about to ride over or the gradient of the uphill road. In this case, at least one of the amplitude Δtemp and the cycle Δt of the target temperature may be varied. The temperature feedback control unit 54 executes temperature feedback control on the periodically varying target temperature Tcmd. With this configuration, a chance that the vehicle can climb the level difference or the uphill road can be increased.

The CPU 21A outputs a warning to the driver of the vehicle 100 while the target temperature is being periodically varied. This can attract attention of the driver.

Routine processing proceeds after the temperature feedback control is started, and in a case where the vehicle 100 remains stopped even when the second torque limitation execution counter cEX2 becomes equal to or more than a predetermined time (that is, even when the predetermined second time has elapsed), the overheat protection mode flag XKANETU is set to 3. While the speed feedback execution counter cEX3 is equal to or less than the predetermined time, the speed feedback control unit 56 releases the limitation of the overheat protection control torque TH and controls the overheat protection control torque TH on the basis of the actual vehicle speed to cause the actual vehicle speed to become the target speed in the extremely low speed range.

That is, the speed feedback control unit 56 executes energization control to control the plurality of power elements 156 by continuously changing the phase of the rotary electrical machine 150 to cause the rotary electrical machine 150 to rotate in a predetermined slow rotation speed range by switching the phase to be energized among the plurality of phases. The energization control in this case is speed feedback control of controlling the plurality of power elements 156 on the basis of the rotation speed of the rotary electrical machine 150 to cause the rotary electrical machine 150 to rotate at the target rotation speed (for example, 25 rpm) within the slow rotation speed range. The speed feedback control is a second measure taken at the time when the overheat protection control torque TH is limited and the vehicle cannot climb a level difference or an uphill road. By executing the speed feedback control in this manner, the single-phase continuous energization state can be avoided, and thus, the temperature rise of the drive device 152 can be suppressed. Because the vehicle can climb a level difference or an uphill road, deterioration of drivability can be prevented. Besides, because the actual vehicle speed is suppressed to the extremely low speed range, the vehicle 100 can be prevented from jumping out after riding over a level difference, and the vehicle can smoothly ride over the level difference.

The target rotation speed may be set in accordance with the operation amount of the accelerator pedal detected by the accelerator sensor. The energization control may be executed on condition that the temperature of the drive device 152 has decreased to a temperature lower than the first threshold (for example, 165° C.) by the temperature feedback control.

The CPU 21A outputs a warning to the driver of the vehicle 100 while the energization control is being executed. This can attract attention of the driver.

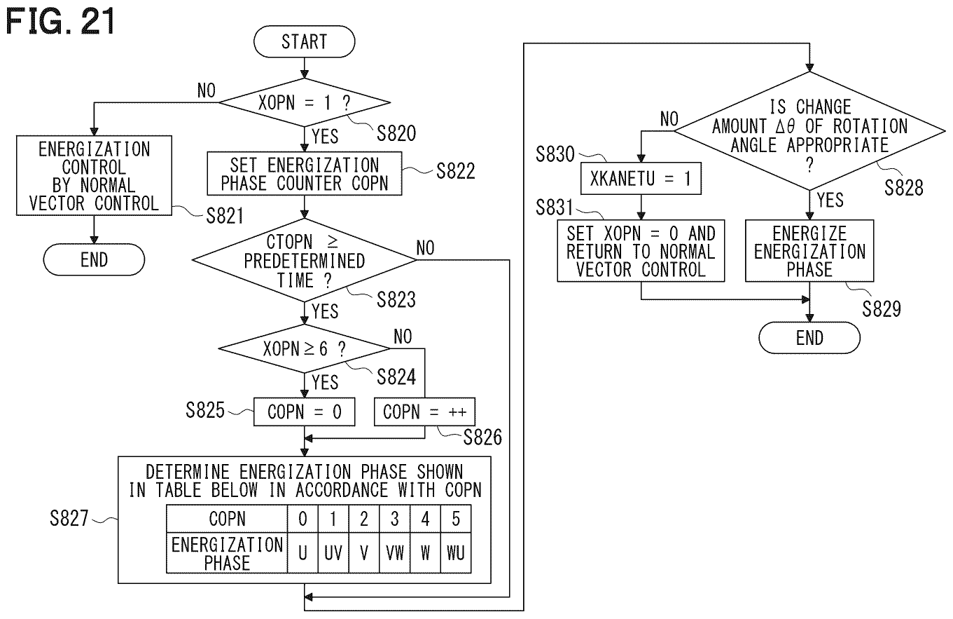

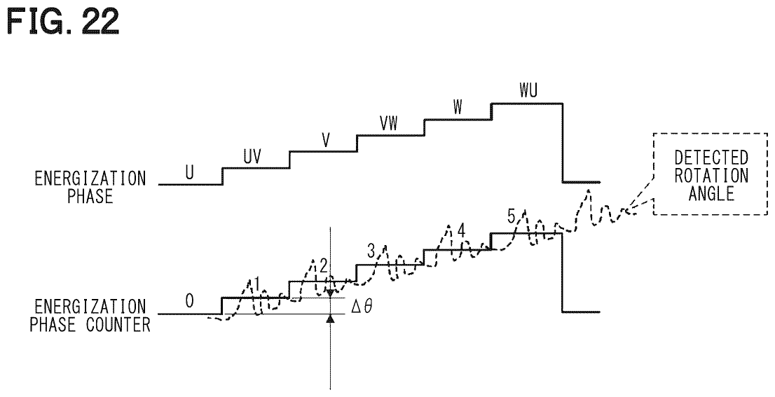

FIG. 21 illustrates a modification of a part of the overheat protection control processing. In the present modification, steps S820 to S831 are executed instead of step S811 of the overheat protection control processing illustrated in FIG. 18. The routine illustrated in steps S820 to S831 is repeatedly executed at predetermined time intervals, for example, every 1 msec. This routine is a routine for controlling the rotary electrical machine 150 in an open loop. That is, the plurality of power elements 156 are energization controlled in an open loop without the rotation angle detected by the rotation speed sensor 211 being used.

In a case where this routine is started, in step S811 of the overheat protection control processing illustrated in FIG. 18, an open-loop control flag XOPN indicating whether control is performed in an open loop is set to 1. That is, after the open-loop control flag XOPN is set to 1 in step S811 of the overheat protection control processing illustrated in FIG. 18, steps S820 to S831 are executed instead of step S811.

In step S820, the CPU 21A determines whether the open-loop control flag XOPN is 1. In a case where the open-loop control flag XOPN is 1, it indicates that the open-loop control is executed, and in a case where the open-loop control flag XOPN is 0, it indicates that the open-loop control is not executed. In a case where open-loop control flag XOPN is 0, the process proceeds to step S821, and in a case where the open-loop control flag XOPN is 1, the process proceeds to step S822.

In step S821, the CPU 21A performs energization control of the plurality of power elements 156 by normal vector control (that is, the speed feedback control using the rotation angle detected by the rotation speed sensor 211).

In step S822, the CPU 21A sets an energization phase counter COPN for switching the energization phase.

In step S823, the CPU 21A determines whether a switching determination counter CTOPN that determines whether to switch the energization phase is a predetermined time or more. As an example, the predetermined time is set to 0.1 seconds, but is not limited thereto. For example, the switching determination counter CTOPN is incremented for every time of this routine. In a case where the switching determination counter CTOPN is equal to or more than the predetermined time, the process proceeds to step S824, and in a case where the switching determination counter CTOPN is less than the predetermined time, the process proceeds to step S828. The switching time of the energization phase described below is defined by the switching determination counter CTOPN.

In step S824, the CPU 21A determines whether the energization phase counter COPN is equal to or more than 6. In a case where the energization phase counter COPN is equal to or more than 6, the process proceeds to step S825, and in a case where the energization phase counter COPN is less than 6, the process proceeds to step S826.

In step S825, the CPU 21A sets the energization phase counter COPN to 0.

In step S826, the CPU 21A increments the energization phase counter COPN.

In step S827, the CPU 21A determines the energization phase in accordance with the energization phase counter COPN. Specifically, the CPU 21A determines the energization phase as the U phase in a case where the energization phase counter COPN is 0, determines the energization phase as the UV phase in a case where the energization phase counter COPN is 1, determines the energization phase as the V phase in a case where the energization phase counter COPN is 2, determines the energization phase as the VW phase in a case where the energization phase counter COPN is 3, determines the energization phase as the W phase in a case where the energization phase counter COPN is 4, and determines the energization phase as the WU phase in a case where the energization phase counter COPN is 5. In this routine, similarly to step S811 described above, the rotary electrical machine 150 is controlled to rotate at the rotation speed (for example, 25 rpm) within the slow rotational speed range.

In step S828, the CPU 21A determines whether the change amount Δθ of the rotation angle detected by the rotation speed sensor 211 (for example, resolver) is appropriate. For example, the CPU 21A determines whether the difference between the change amount of the rotation angle based on the energization phase counter COPN and the change amount Δθ of the rotation angle detected by the rotation speed sensor 211 is appropriate on the basis of whether the difference falls within a predetermined range. In a case where the change amount Δθ of the rotation angle is appropriate, the process proceeds to step S829, and in a case where the change amount Δθ of the rotation angle is not appropriate, the process proceeds to step S830.

In step S829, the CPU 21A controls the inverter 151 to energize the energization phase. This causes the open-loop control to be executed. In addition, the CPU 21A executes the open-loop control while confirming that the change amount Δθ of the rotation angle of the rotary electrical machine 150 is appropriate. FIG. 20 illustrates an example of the relationship among the energization phase, the energization phase counter COPN, and the detected rotation angle.

In step S830, the CPU 21A sets the overheat protection mode flag XKANETU to 1.

In step S831, the CPU 21A sets the open-loop control flag XOPN to 0, and returns to the normal vector control (that is, torque limitation processing by the temperature feedback control in a case where the overheat protection mode flag XKANETU is 1).

As described above, in the present modification, the plurality of power elements 156 are energization controlled by the open-loop control. This allows the processing load to be reduced as compared with the speed feedback control.

In the present modification, the open-loop control is executed while it is confirmed that the change amount Δθ of the rotation angle of the rotary electrical machine 150 is appropriate. This can suppress erroneous energization and step-out of the rotary electrical machine 150 can be suppressed. In a case where the change amount Δθ of the rotation angle of the rotary electrical machine 150 is not appropriate, because the control returns to the normal vector control, recovery can be performed even if the rotary electrical machine 150 steps out.

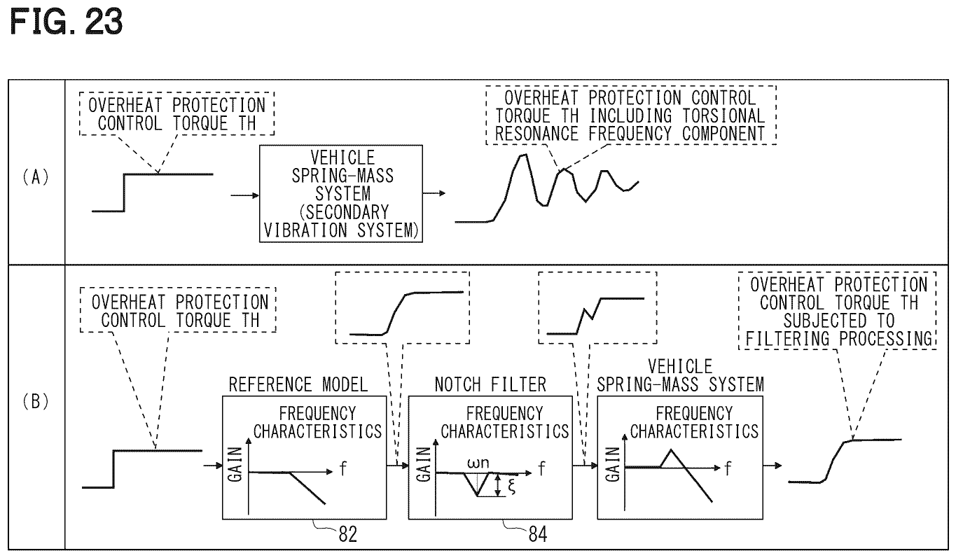

Next, details of the filtering processing by the filtering processing unit 58 will be described with reference to FIG. 23.

(A) in FIG. 23 illustrates a case where the overheat protection control torque TH is not subjected to filtering processing, and (B) in FIG. 23 illustrates a case where the overheat protection control torque TH is subjected to filtering processing. The vehicle 100 includes a spring-mass system (that is, a secondary vibration system). The spring-mass system includes, for example, a drive shaft connected to the rotary electrical machine 150 in a manner that the power can be transmitted. In a case where the overheat protection control torque TH is not subjected to filtering processing, when the rotary electrical machine 150 rotates with the overheat protection control torque TH, the overheat protection control torque TH including a torsional resonance frequency component by the drive shaft is applied to the wheel. In this case, the overheat protection control torque TH fluctuates, and the drivability deteriorates.

Meanwhile, the filtering processing unit 58 according to the present embodiment includes a reference model 82 and a notch filter 84. The reference model 82 has frequency characteristics in which the gain decreases beyond a certain frequency. The spring-mass system of the vehicle 100 has frequency characteristics in which the gain indicates a change having a protrusion shape, the gain having a peak at the resonance frequency, but the notch filter 84 has frequency characteristics in which the gain indicates a change having a V-notch shape opposite to the protrusion shape, the gain having a bottom at the resonance frequency. By performing the filtering processing on the overheat protection control torque TH by using the notch filter 84 in this manner, the overheat protection control torque TH can be reduced, and the torsional resonance frequency component due to the drive shaft can be attenuated. This can suppress the fluctuation of the overheat protection control torque TH and improve the drivability.

Next, details of the permission determination processing of the stepping error prevention control in step S200 in FIG. 8 will be described with reference to FIGS. 24 and 25. FIG. 24 illustrates permission determination processing for determining whether to permit the stepping error prevention control, and FIG. 25 illustrates prohibition determination processing for determining whether to prohibit the stepping error prevention control.

In step S900, the CPU 21A determines whether the vehicle speed is equal to or less than a predetermined speed. The predetermined speed is set to a relatively low speed, and in the present embodiment, the predetermined speed is set to 9 kph as an example, but is not limited thereto. Then, in a case where the vehicle speed is equal to or less than the predetermined speed, the process proceeds to step S901, and in a case where the vehicle speed is higher than the predetermined speed, the process proceeds to step S909 in FIG. 25.

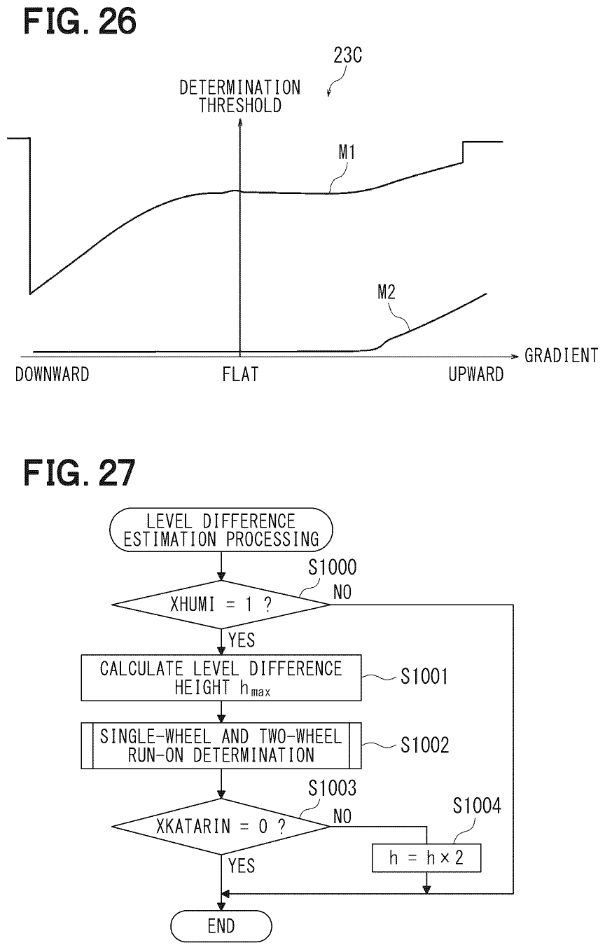

In step S901, the CPU 21A determines whether the accelerator opening degree is larger than a determination threshold. The predetermined threshold is determined on the basis of the determination threshold map data 23C. FIG. 26 illustrates an example of the determination threshold map data 23C of the accelerator opening degree. As illustrated in FIG. 26, the determination threshold map data 23C includes a permission determination processing map M1 and a prohibition determination map M2. In FIG. 26, the horizontal axis represents the gradient of the road surface, the vertical axis represents the determination threshold, and the determination threshold changes in accordance with the gradient of the road surface. As illustrated in FIG. 26, in the permission determination processing map M1, the determination threshold is set to a maximum value in a region where the downward gradient is too large and a region where the upward gradient is too large. Among the regions other than the region where the downward gradient is too large and the region where the upward gradient is too large, the determination threshold gradually increases in the region from where the gradient is downward to flat, and the determination threshold is substantially constant in the region where the gradient is flat. In a region from where the gradient is flat to upward, the determination threshold gradually increases. In the prohibition determination processing map M2, the determination threshold is substantially 0 in a region from where the gradient is downward to upward to some extent, and the determination threshold gradually increases in a region further upward from the region.

In this manner, the determination threshold is set in accordance with the gradient of the road surface. Therefore, in step S901, the CPU 21A first acquires the accelerator opening degree and the gradient of the road surface. The accelerator opening degree can be acquired from the accelerator sensor 205. The gradient of the road surface can be acquired from the gradient sensor 207. Next, the CPU 21A acquires a determination threshold corresponding to the acquired gradient of the road surface from the permission determination processing map M1. Then, it is determined whether the accelerator opening degree is larger than the determination threshold. In a case where the accelerator opening degree is larger than the determination threshold, the process proceeds to step S902, and in a case where the accelerator opening is equal to or less than the determination threshold, the process proceeds to step S909 in FIG. 25.

In step S902, the CPU 21A determines whether the brake hydraulic pressure is equal to or less than a predetermined threshold. The brake hydraulic pressure can be acquired from the brake sensor 208. The predetermined threshold is set to a value with which the brake of the vehicle 100 can be determined to be off as long as the brake hydraulic pressure is equal to or less than the predetermined threshold. In a case where the brake hydraulic pressure is equal to or less than the predetermined threshold, that is, in a case where the brake of the vehicle 100 is off, the process proceeds to step S903, and in a case where the brake hydraulic pressure is larger than the predetermined threshold, that is, in a case where the brake of the vehicle 100 is on, the process proceeds to step S909 in FIG. 25.

In step S903, the CPU 21A determines whether the parking brake of the vehicle 100 is off. Whether or not the parking brake is off can be acquired from the parking sensor 209. In a case where the parking brake is off, the process proceeds to step S904, and in a case where the parking brake is on, the process proceeds to step S909 in FIG. 25.

In step S904, the CPU 21A determines whether a shift lever of the vehicle 100 is in a mode other than parking and neutral. That is, it is determined whether the shift lever is in a mode in which the vehicle 100 can travel such as drive or reverse. Then, in a case where the shift lever of the vehicle 100 is in a mode other than parking and neutral, the process proceeds to step S905, and in a case where the shift lever of the vehicle 100 is not in a mode other than parking and neutral, the process proceeds to step S909 in FIG. 25.

In step S905, the CPU 21A determines whether the CXHUMI, which is a counter for a time during which the stepping error prevention control is permitted, is equal to or less than a predetermined time. In the present embodiment, as an example, the predetermined time is set to 1 second, but is not limited thereto. In a case where the counter CXHUMI is equal to or less than the predetermined time, the process proceeds to step S906, and in a case where the counter CXHUMI exceeds the predetermined time, the process proceeds to step S909 in FIG. 25.

In step S906, the CPU 21A determines whether CRETRY, which is a counter for counting the time elapsed since the previous stepping error prevention control has been prohibited, is equal to or more than a predetermined time. In the present embodiment, as an example, the predetermined time is set to 30 seconds, but is not limited thereto. In a case where the counter CRETRY is equal to or more than the predetermined time, the process proceeds to step S907, and in a case where the counter CRETRY exceeds the predetermined time, the process proceeds to step S909 in FIG. 25.

In step S907, XHUMI which is a flag indicating whether the execution of the stepping error prevention control is permitted is set to 1. In a case where XHUMI is 1, it indicates that the execution of the stepping error prevention control is permitted. On the other hand, In a case where XHUMI is 0, it indicates that the execution of the stepping error prevention control is prohibited.

In step S908, the CPU 21A increments the counter CXHUMI by the following formula.

CXHUMI=CXHUMI+1 (5)

In step S909 in FIG. 25, the CPU 21A determines whether the flag XHUMI is 1. That is, it is determined whether the execution of the stepping error prevention control is permitted. In a case where the flag XHUMI is 1, that is, in a case where the execution of the stepping error prevention control is permitted, the process proceeds to step S910. On the other hand, in a case where the flag XHUMI is 0, that is, in a case where the execution of the stepping error prevention control is prohibited, the process proceeds to step S915.

In step S910, the CPU 21A determines whether the accelerator opening degree is 0%. In a case where the accelerator opening degree is 0%, the process proceeds to step S911, and in a case where the accelerator opening is not 0%, the process proceeds to step S916.

In step S911, the CPU 21A determines whether the vehicle speed is 0 kph. In a case where the vehicle speed is 0 kph, the process proceeds to step S912, and in a case where the vehicle speed is not 0 kph, the process proceeds to step S916.

In step S912, the CPU 21A determines whether the brake hydraulic pressure is larger than a predetermined threshold. In a case where the brake hydraulic pressure is larger than the predetermined threshold, that is, in a case where the brake is on, the process proceeds to step S913, and in a case where the brake hydraulic pressure is equal to or less than the predetermined threshold, that is, in a case where the brake is off, the process proceeds to step S916.

In step S913, the CPU 21A sets the flag XHUMI to 0. That is, the execution of the stepping error prevention control is prohibited.

In step S914, the CPU 21A sets the counter CRETRY to 0. That is, the counter CRETRY is reset.

In step S915, the CPU 21A increments the counter CRETRY by the following formula.

$$CRET R Y = C R E T R Y + 1 \qquad ( 6 )$$

In step S916, the CPU 21A determines whether a level difference ride-over request by the driver is on. The determination as to whether the level difference ride-over request by the driver is on may be made by, for example, providing a release switch and determining whether the driver has turned on the release switch. It may be determined whether the level difference ride-over request by the driver is on depending on whether the driver has operated the direction indicator. This is because, in a case where the driver operates the direction indicator, it is considered that, for example, the driver intends to ride the vehicle 100 over a road shoulder having a level difference. In a case where the level difference ride-over request by the driver is on, the process proceeds to step S918, and in a case where the level difference ride-over request by the driver is off, the process proceeds to step S917.

In step S917, the CPU 21A determines whether the counter CXHUMI has exceeded a predetermined time. In the present embodiment, as an example, the predetermined time is set to 10 seconds, but is not limited thereto. In a case where the counter CXHUMI has exceeded the predetermined time, the process proceeds to step S918, and in a case where the counter CXHUMI is equal to or less than the predetermined time, this routine is ended.

In step S918, the CPU 21A sets the flag XHUMI to 0. That is, the execution of the stepping error prevention control is prohibited.

In step S919, the CPU 21A sets the counter CXHUMI to 0. That is, the counter CXHUMI is reset.

As described above, the permission to execute the stepping error prevention control is received until 1 second elapses after the accelerator operation is performed. In a case where it is determined that the vehicle 100 is stopped because the accelerator operation is off or the like, the execution of the stepping error prevention control is prohibited. For example, in a case where the driver really wants to perform riding over, such as in a case where the wheel gets stuck in a hole and the driver wants to get the vehicle out from the hole, in a case where there is an obstacle in front of the vehicle and the driver really wants to ride over the obstacle, or in a case where the driver wants to ride over a level difference on the road shoulder to park the vehicle by tandem parking, the stepping error prevention control is prohibited and the torque control by the accelerator operation is restored.

In a case where it is detected that the accelerator is depressed again after the accelerator operation is turned off and the stepping error prevention control is prohibited, it is assumed that the driver desires to release the accelerator, and the stepping error prevention control may be prohibited again.

Next, details of the level difference estimation processing in step S201 in FIG. 8 will be described with reference to FIG. 27.

In step S1000, the CPU 21A determines whether the flag XHUMI is 1, that is, whether the execution of the stepping error prevention control is permitted. In a case where the flag XHUMI is 1, that is, in a case where the stepping error prevention control is permitted, the process proceeds to step S1001, and in a case where the flag XHUMI is 0, that is, in a case where the stepping error prevention control is prohibited, this routine is ended.

In step S1001, the CPU 21A calculates a maximum value hₘₐₓ of the height h of the level difference. Specifically, first, a vertical load Fz is calculated. The vertical load Fz is a force applied downward to the wheels 111 and 112 that are driven wheels. The vertical load Fz is calculated as the total value of forces received by the wheels 111 and 112 by the following formula.

$${F}_{Z} = mg ( \frac{{l}_{r}}{l} - \frac{{G}_{x} {h}_{c g}}{l} ) + {d}_{s} {V}_{s p d} {tan θ}_{old} \qquad ( 7 )$$

“m” in the first term on the right side of the above formula (7) is the weight of the vehicle 100. “g” is the gravitational acceleration. “l” is the length of a wheelbase of the vehicle 100. “lr” is a length from the center of gravity of the vehicle 100 to the rotation center axis of the rear wheels (wheels 121, 122) along the front-rear direction. “G_{X}” is the acceleration along the traveling direction, that is, the front-rear direction of the vehicle 100. “h_{cg}” is the height from the road surface to the center of gravity of the vehicle 100. The first term on the right side of the above formula (7) represents a component in a downward direction of the force applied to each of the wheels 111 and 112 as a dynamic load at the time when the vehicle 100 travels.

“d_{S}” in the second term on the right side of the above formula (7) is a damping coefficient of a damper (not illustrated) of the vehicle 100. “V_{Spd}” is a traveling speed along the front-rear direction of the vehicle 100. Vs can be calculated, for example, on the basis of a signal from the wheel speed sensor 201. “θ_{old}” is a value of a trajectory angle θ calculated in the previous control cycle. At the time when the processing in FIG. 27 is executed for the first time, for example, 0 is used as the value of θ_{old}. The second term on the right side of the above formula (7) represents a force applied to each of the wheels 111 and 112 as the damper expands and contracts.

Next, the trajectory angle θ is calculated. Here, the trajectory angle θ will be described. The “trajectory angle” is an angle formed by the trajectory of the rotation center axis of the wheel 111 or the like with respect to the road surface.

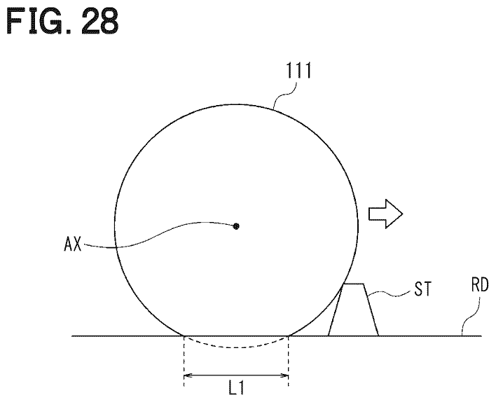

FIG. 28 schematically illustrates a state in which the wheel 111 is on a road surface RD. A level difference ST that is a wheel stopper is provided on the road surface RD, and a part of the wheel 111 is in contact with the level difference ST. In a case where the vehicle 100 further travels toward the right side (that is, the level difference ST side) from the state in FIG. 28, the wheel 111 rides over the level difference ST.

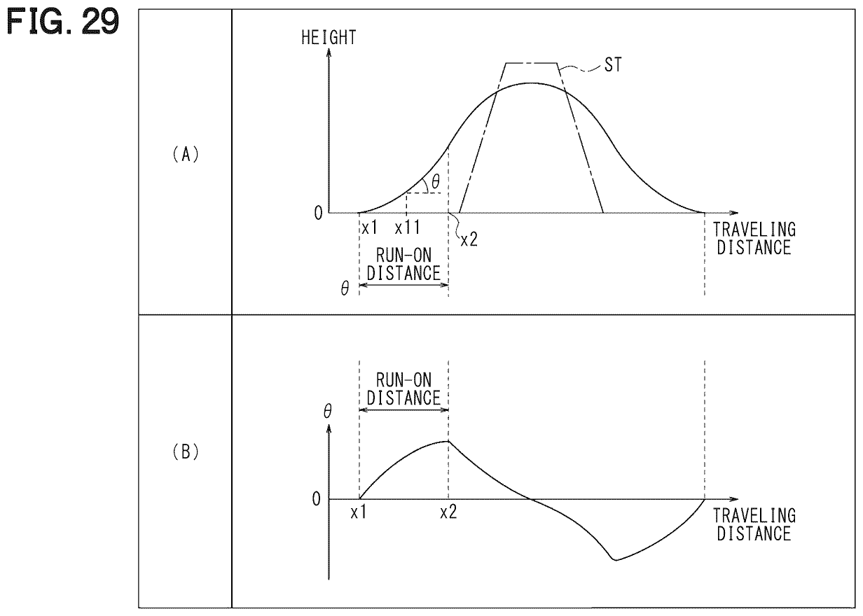

A graph indicated by a solid line in (A) in FIG. 29 indicates the relationship between the travel distance (horizontal axis) of the vehicle 100 and the height (vertical axis) of a rotation center axis AX of the wheel 111 in a case where the vehicle 100 travels rightward as described above. It can be said that the graph represents a trajectory of the rotation center axis AX during traveling of the vehicle 100. θ illustrated in (A) in FIG. 29 is an angle formed by the trajectory of the rotation center axis AX of the wheel 111 or the like with respect to the road surface, and represents a trajectory angle at the time when the vehicle 100 is at a position of X1. Such a trajectory angle θ can be defined corresponding to each position of the vehicle 100.

As described above, the “trajectory angle” is an angle formed by the trajectory of the rotation center axis AX of the wheel 111 or the like with respect to the road surface, and the “trajectory of the rotation center axis AX” referred to herein is a trajectory of the rotation center axis AX in a case where the vehicle 100 is viewed along the left-right direction (vehicle width direction) thereof. The trajectory of the rotation center axis AX as shown in the graph of (A) in FIG. 29 reflects, to some extent, the shape of the level difference ST indicated by a one-dot chain line in (A) in FIG. 29. The reason why the two shapes are different from each other is because the wheel 111 is not a rigid body and the wheel 111 is deformed by hitting the level difference ST.

The trajectory angle θ can be calculated by the following formula.

$$θ = a sin ( \frac{m g * {G}_{x} - \frac{{{T}_{mg}}_{}}{R} {cos θ}_{old}}{{F}_{Z}} ) \qquad ( 8 )$$

“T_{mg}” on the right side of the above formula (8) is the torque of the rotary electrical machine 150, and “R” is the dynamic radius of the wheel 111. “T_{mg}/R” indicates the driving force applied to the road surface by the drive wheel of the vehicle 100. The torque T_{mg} of the rotary electrical machine 150 can be acquired, for example, by acquiring the value of the driving current flowing through the rotary electrical machine 150 by the current sensor 203 and calculating the torque on the basis of the magnitude of the acquired driving current.

Next, a trajectory angle θ′ in a case where the wheel 111 is an ideal disk is calculated from the trajectory angle θ by the following formula.

$${θ}^{′} = \frac{π}{2} + θ - a cos ( \frac{L}{2 R} ) \qquad ( 9 )$$

Here, L is a ground contact length of the wheel 111. The ground contact length L is a run-on distance (x2-x1) in (A) and (B) in FIG. 29. The graph of (B) in FIG. 29 illustrates an example of a change in the trajectory angle θ at the time when the vehicle 100 rides over the level difference ST as illustrated in (A) in FIG. 29.

“X1” shown in (A) and (B) in FIG. 29 is the position of the vehicle 100 at the time when the wheel 111 or the like comes into contact with the level difference ST. “X2” shown in (A) and (B) in FIG. 29 is the position of the vehicle 100 at the time when the wheel 111 or the like is separated from the road surface. The position is a position corresponding to an inflection point in the graph of (A) in FIG. 29 and a position corresponding to a peak value in the graph of (B) in FIG. 29.

The “run-on distance” is a distance from X1 to X2, that is, a distance that the vehicle 100 travels from when the wheel 111 or the like comes into contact with the level difference ST until when the wheel 111 or the like is separated from the road surface. In other words, the “run-on distance” can also be referred to as a distance traveled by the vehicle 100 in a period from when the trajectory angle θ starts of increase to when the trajectory angle θ starts to decrease.

The run-on distance defined in this manner is correlated with the length (L1 in FIG. 23) along the front-rear direction of the portion of the wheel 111 or the like in contact with the road surface RD at the time when the vehicle 100 is stopped on the flat road surface RD. Therefore, as the air pressure of the wheel 111 or the like decreases, L1 illustrated in FIG. 28 tends to become longer, and the run-on distance illustrated in (A) and (B) in FIG. 29 also tends to become longer.

The height h of the level difference ST can be calculated by the following formula in a case where the wheel 111 is an ideal disk.

$$h = R - {R cosθ}^{′} = R ( 1 - sin ( a cos ( \frac{L}{2 R} ) - θ ) \qquad ( 10 )$$

Here, in a case where it is assumed that θ in the above formula (10) is θₘₐₓ, which is the maximum value of the trajectory angle θ, the maximum value hₘₐₓ of the height of the level difference ST can be calculated.

The trajectory angle θₘₐₓ can be calculated by the following formula.

$${θ}_{max} = κ \times L \qquad ( 11 )$$

Here, κ is a change rate of the trajectory angle θ, and can be calculated by the following formula.

$$k = \frac{d θ}{d x} = filter ( \frac{\frac{d θ}{dx}}{\frac{dx}{dt}} ) = filter ( \frac{\dot{θ}}{Vx} , 2 Hz ) \qquad ( 12 )$$

Here, the filter( ) is a function that performs filter processing of attenuating a high frequency component, and is a function having a function of blunting, that is, moderating the change amount of the trajectory angle θ. Vₓ is a vehicle speed.

From the above, the maximum value hₘₐₓ of the height of the level difference ST can be calculated by the following formula.

$${h}_{max} = R ( 1 - sin ( a cos ( \frac{L}{2 R} ) - filter ( \frac{\dot{θ}}{Vx} , 2 Hz ) \times L ) \qquad ( 13 )$$

Hereinafter, the maximum value hₘₐₓ of the height of the level difference ST is simply referred to as the height h of the level difference ST.

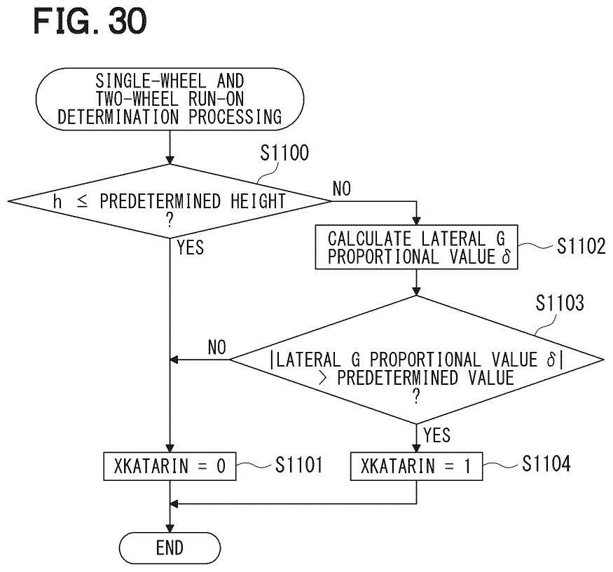

In step S1002, the CPU 21A executes single-wheel and two-wheel run-on determination processing illustrated in FIG. 30.

In step S1100, the CPU 21A determines whether the level difference height h calculated in step S1001 in FIG. 27 is equal to or less than a predetermined height. In the present embodiment, as an example, the predetermined height is set to 2 cm, but is not limited thereto. Then, in a case where the level difference height h is equal to or less than the predetermined height, the process proceeds to step S1101, and in a case where the level difference height h is higher than the predetermined height, the process proceeds to step S1102.

In step S1101, a flag XKATARIN is set to 0, the flag XKATARIN indicating whether a single wheel is about to ride over the level difference ST or two wheels are about to ride over the level difference ST. In a case where the flag XKATARIN is 0, it indicates a state in which two wheels are about to ride over the level difference ST, and in a case where the flag XKATARIN is 1, it indicates a state in which a single wheel is about to ride over the level difference ST.

In step S1102, the CPU 21A calculates a lateral G proportional value δ by the following formula.

$$δ = \frac{{G}_{y} * K}{max ( {V}_{x} \cdot r , const )} \qquad ( 14 )$$

Here, G_{y} is lateral G, that is, acceleration along the left-right direction of the vehicle 100, and can be acquired from the acceleration sensor 202. K is a predetermined coefficient. Vₓ is a vehicle speed. r is a yaw rate, and can be acquired from the yaw rate sensor 210. const is a predetermined coefficient for preventing the denominator from becoming zero.

In a case where a single wheel has run on the level difference ST, the vehicle 100 is more inclined than in a case where two wheels have run on the level difference ST, and thus, the inclination is detected as the lateral G. In order to cancel a portion of the lateral G generated at the time of turning of the vehicle 100, it is determined whether a single wheel is about to ride over the level difference ST or two wheels are about to ride over the level difference ST on the basis of the lateral G proportional value b obtained by comparing the lateral G with the lateral G calculated from the yaw rate r.

In step S1103, the CPU 21A determines whether the absolute value of the lateral G proportional value δ calculated in step S1002 is larger than a predetermined value. In a case where the absolute value of the lateral G proportional value δ is larger than the predetermined value, the process proceeds to step S1104, and in a case where the absolute value of the lateral G proportional value δ is equal to or less than the predetermined value, the process proceeds to step S1101.

In step S1104, the CPU 21A sets the flag XKATARIN to 1.

Returning to FIG. 27, in step S1003, the CPU 21A determines whether the flag XKATARIN is 0. That is, it is determined whether two wheels are about to ride over the level difference ST. Then, in a case where the flag XKATARIN is 0, this routine is ended, and in a case where the flag XKATARIN is 1, the process proceeds to step S1004.

In step S1004, the CPU 21A doubles the height h of the level difference ST by the following formula. That is, in a case where a single wheel is about to ride over the step ST, the height h of the level difference ST is set twice.

$$h = h \times 2 \qquad ( 15 )$$

Next, details of the stepping error determination processing in step S202 in FIG. 8 will be described with reference to FIG. 31. Hereinafter, a case where the shift is in the D range (forward) will be described.

In step S1200, the CPU 21A determines whether the flag XHUMI is 1. That is, it is determined whether the execution of the stepping error prevention control is permitted. In a case where the flag XHUMI is 1, that is, in a case where the stepping error prevention control is permitted, the process proceeds to step S1201, and in a case where the flag XHUMI is 0, that is, in a case where the stepping error prevention control is prohibited, the process proceeds to step S1208.

In step S1201, the CPU 21A determines whether the vehicle speed is equal to or less than a predetermined speed. The predetermined speed is set to a speed at which it can be determined that the vehicle 100 is traveling at a low speed, and is set to 1 kph as an example in the present embodiment, but is not limited thereto.

Then, in a case where the vehicle speed is equal to or less than the predetermined speed, the process proceeds to step S1202, and in a case where the vehicle speed exceeds the predetermined speed, the process proceeds to step S1204.

In step S1202, the CPU 21A determines whether the height h of the level difference ST is higher than a first predetermined height. In the present embodiment, as an example, the first predetermined height is set to 13.5 cm, but is not limited thereto. Then, in a case where the height h of the level difference ST is higher than the first predetermined height, the process proceeds to step S1203, and in a case where the height h of the level difference ST is equal to or less than the first predetermined height, the process proceeds to step S1204.

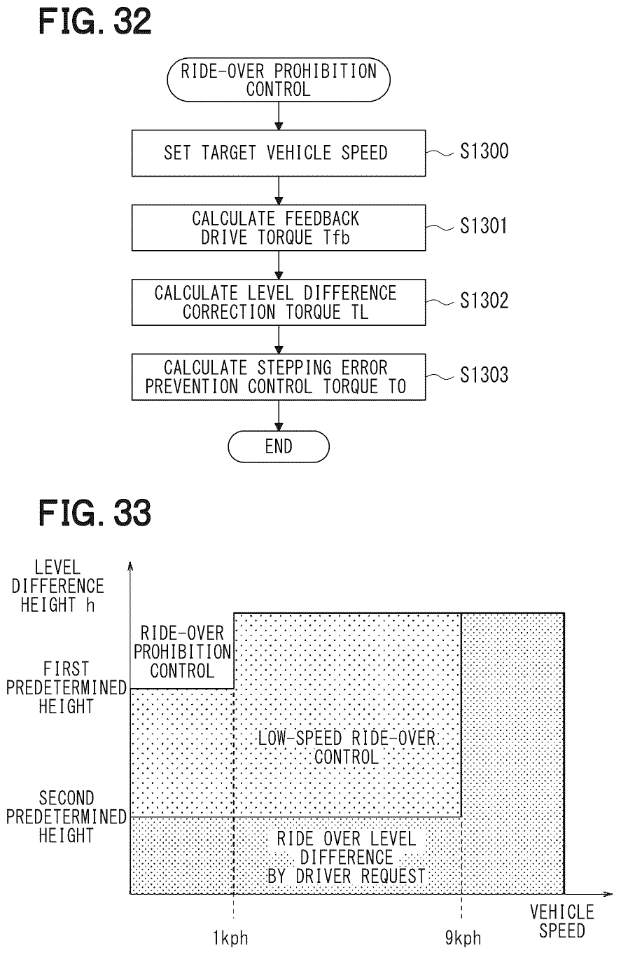

In step S1203, the CPU 21A executes the ride-over prohibition control illustrated in FIG. 32.

In step S1300, the CPU 21A sets a target vehicle speed. In the present embodiment, as an example, the target vehicle speed is set to 0 kph, but is not limited thereto.

In step S1301, the CPU 21A calculates, by the following formula, a feedback drive torque Tfb for performing proportional-integral (PI) feedback control to cause the vehicle speed to become the target vehicle speed set in step S1300.

$$Tfb = Kp \times e + Ki \times \int e \qquad ( 16 )$$

Here, Kp is a proportional gain. Ki is an integral gain. Tfb is limited between a predetermined upper limit and a predetermined lower limit.

In step S1302, the CPU 21A sets a level difference correction torque TL that cancels the load torque corresponding to the height h of the level difference ST. Here, TL is set to 0 in a case where the target vehicle speed is 0 kph.

In step S1303, the CPU 21A calculates a stepping error prevention control torque TO by the following formula.

$$TO = Tfb + TL + TU \qquad ( 17 )$$

Here, the TU is a torque set in accordance with the gradient of the road surface, and can be acquired by using the gradient torque map data 23D in which the correspondence relationship between the gradient and the gradient torque TU is predetermined.

Note that, in a case where the shift is in the R range (backward), the ride-over prohibition control in FIG. 27 is executed similarly to the case where the shift is in the D range.

Returning to FIG. 31, in step S1204, the CPU 21A determines whether the height h of the level difference ST is higher than a second predetermined height. The second predetermined height is set to a height lower than the first predetermined height, and in the present embodiment, is set to 6.5 cm as an example, but is not limited thereto. Then, in a case where the height h of the level difference ST is higher than the second predetermined height, the process proceeds to step S1205, and in a case where the height h of the level difference ST is equal to or less than the second predetermined height, the process proceeds to step S1208.

In step S1205, the CPU 21A executes low-speed ride-over control. The low-speed ride-over control is basically similar to the ride-over prohibition control in FIG. 32, but the processing in steps S1300 and S1302 is different.

First, the target vehicle speed set in step S1300 is different. In the low-speed ride-over control, the target vehicle speed is set to, for example, 1 kph, but is not limited thereto.

In step S1302, the level difference correction torque TL is calculated by the following formula.

$$TL = R \times Fz \times tan ( θ ) \qquad ( 18 )$$

Note that the low-speed ride-over control in a case where the shift is in the R range (backward) is similar to the case where the shift is in the D range in the processing other than setting the target vehicle speed to −1 kph in step S1300.

Returning to FIG. 31, in step S1206, the CPU 21A sets the level difference ride-over control flag XEX to 1. In a case where the level difference ride-over control flag XEX is 1, it indicates that the torque correction by the stepping error prevention control torque TO is being executed, that is, the ride-over prohibition control in step S1203 or the low-speed ride-over control in step S1205 is being executed. On the other hand, in a case where the level difference ride-over control flag XEX is 0, it indicates that the torque correction by the stepping error prevention control torque TO is not being executed, that is, neither the ride-over prohibition control in step S1203 nor the low-speed ride-over control in step S1205 is being executed.

In step S1207, the CPU 21A executes processing of warning the driver. Specifically, for example, a message such as “Please release the pedal and stop the vehicle” is displayed on a meter, or a message is output from a speaker by voice.

FIG. 33 illustrates the relationship among the vehicle speed, the level difference height h, and the level difference ride-over control. In a case where the vehicle speed is equal to or less than a first speed (1 kph) and the level difference height h is higher than the first predetermined height, the ride-over prohibition control is performed. In a case where the vehicle speed is higher than a second speed (9 kph) or in a case where the level difference height h is equal to or less than the second predetermined height, control is performed to ride over the level difference at the request of the driver. In a case where the vehicle speed is equal to or less than 9 kph, regarding a case where the level difference height h is higher than the second predetermined height and equal to or less than the first predetermined height and in a case where the vehicle speed is faster than 1 kph and equal to or less than 9 kph, in a case where the level difference height h is higher than the first predetermined height, the low-speed ride-over control is performed to ride over the level difference at 1 kph.

Although the present embodiment has been described above, the present disclosure is not limited to each embodiment described above, and various modifications and applications can be made without departing from the gist of the present disclosure.

The configuration of the vehicle control device 10 described in the above embodiment (see FIG. 2) is an example, and it goes without saying that an unnecessary portion may be deleted or a new portion may be added without departing from the gist of the present disclosure.

The flow of the processing of the vehicle control program 23A described in the above embodiment is also an example, and it goes without saying that unnecessary steps may be deleted, new steps may be added, or the processing order may be changed within a range not departing from the gist of the present disclosure.

The control unit and the method thereof described in the present disclosure may be realized by a dedicated computer constituting a processor programmed to execute one or a plurality of functions embodied by a computer program. Alternatively, the device and the method thereof described in the present disclosure may be realized by a dedicated computer constituting a processor by using a dedicated hardware logic circuit. Alternatively, the device and the method thereof described in the present disclosure may be realized by one or more dedicated computers configured by combining a processor that executes a computer program and one or more hardware logic circuits. The computer program may be stored in a computer-readable non-transition tangible recording medium as an instruction executed by a computer.

The present disclosure is described based on the examples, and it is understood that present disclosure is not limited to the embodiments or the structures. The present disclosure includes various modification examples and modifications within the equivalent scope. Although various combinations and forms are set forth in the present disclosure, other combinations and configurations, including only one element, more, or less, are also intended to fall within the scope and spirit of the present disclosure.

What is claims:

1. A vehicle control device comprising:
at least one of (i) a circuit and (ii) a processor with a memory storing computer program code executable by the processor, the at least one of the circuit and the processor configured to cause the vehicle control device to:
estimate temperature of a drive device, which includes a rotary electrical machine configured to drive a vehicle and an inverter connected to the rotary electrical machine, based on a temperature detection value of at least one power element of a plurality of power elements of the inverter and a current value of each of the power elements;
in a state in which the drive device is overloaded, control torque of the rotary electrical machine based on the temperature as estimated to decrease temperature of the drive device;
estimate temperature of the drive device based on the temperature detection value, when rotation speed of the rotary electrical machine is higher than predetermined rotation speed in a vicinity of a rotational stop; and
estimate temperature of the drive device based on the temperature detection value and a current value for each of the power elements, when the rotation speed of the rotary electrical machine is equal to or less than the predetermined rotation speed in the vicinity of the rotational stop.

2. The vehicle control device according to claim 1, wherein
the state in which the drive device is overloaded is a state in which, when the vehicle rides over a level difference or travels on an uphill road, the vehicle stops due to load torque, which acts on the rotary electrical machine and balances with torque of the rotary electrical machine.

3. The vehicle control device according to claim 1, wherein
the temperature detection value is from a temperature sensor provided to any one of the plurality of power elements.

4. The vehicle control device according to claim 1, wherein
the temperature detection value is from a temperature sensor provided to any one of the plurality of power elements, and
the at least one of the circuit and the processor is further configured to cause the vehicle control device to
when rotation speed of the rotary electrical machine is higher than the predetermined rotation speed in the vicinity of the rotational stop,
estimate temperature of each of the power elements based on the temperature detection value, and
estimate temperature of the drive device based on estimated temperature of each of the power elements, and
when the rotation speed of the rotary electrical machine is equal to or less than the predetermined rotation speed in the vicinity of the rotation stop,
estimate temperature of each of the power elements based on the temperature detection value and the current value of each of the power elements, and
estimate temperature of the drive device based on the estimated temperature of each of the power elements.

5. The vehicle control device according to claim 1, wherein
the temperature detection value is from a temperature sensor provided for each of the power elements, and
the at least one of the circuit and the processor is further configured to cause the vehicle control device to estimate temperature of the drive device based on each of temperature detection values.

6. The vehicle control device according to claim 4, wherein
the at least one of the circuit and the processor is further configured to cause the vehicle control device to estimate, as temperature of the drive device, a highest temperature among the estimated temperature of the respective power elements.

7. The vehicle control device according to claim 1, wherein
the drive device has a plurality of phases, and
the at least one of the circuit and the processor is further configured to cause the vehicle control device to cause the vehicle control device to estimate temperature of the drive device based on the temperature detection value and the current value for each of the power elements, when the drive device becomes a single-phase continuous energization state, in which a current continuously flows in any one of the plurality of phases as a result of the drive device being overloaded and the vehicle being stopped.

8. The vehicle control device according to claim 1, wherein
the at least one of the circuit and the processor is further configured to cause the vehicle control device to
estimate heat generation energy based on the current value for each of the power elements,
estimate heat radiation energy based on the temperature detection value and temperature of cooling water for cooling the inverter, and
estimate temperature of the drive device based on the heat generation energy and the heat radiation energy.

9. The vehicle control device according to claim 1, wherein
the at least one of the circuit and the processor is further configured to cause the vehicle control device to, when temperature as estimated is equal to or more than a predetermined first threshold, set a target temperature lower than the first threshold, and execute temperature feedback control to control torque of the rotary electrical machine to cause the temperature of the drive device to become the target temperature.

10. The vehicle control device according to claim 9, wherein
the at least one of the circuit and the processor is further configured to cause the vehicle control device to periodically vary the target temperature, when the vehicle remains stopped even when a predetermined first time has elapsed after starting the temperature feedback control.

11. The vehicle control device according to claim 10, wherein
the at least one of the circuit and the processor is further configured to cause the vehicle control device to output warning to a driver of the vehicle while periodically varying the target temperature.

12. The vehicle control device according to claim 10, wherein,
the at least one of the circuit and the processor is further configured to cause the vehicle control device to, when periodically varying the target temperature, vary at least one of, in accordance with height of level difference that the vehicle is about to ride over,
an amplitude of the target temperature,
an amplitude of the target temperature, or
a gradient of an uphill road.

13. The vehicle control device according to claim 1, wherein
the drive device has a plurality of phases, and
the at least one of the circuit and the processor is further configured to cause the vehicle control device to, when the drive device is overloaded, execute energization control to control the plurality of power elements to cause the rotary electrical machine to rotate in a predetermined slow rotation speed range by switching a phase to be energized among the plurality of phases.

14. The vehicle control device according to claim 13, wherein
the at least one of the circuit and the processor is further configured to cause the vehicle control device to,
when temperature as estimated is equal to or more than a predetermined first threshold, set a target temperature, which is lower than the first threshold and execute temperature feedback control to control torque of the rotary electrical machine to cause the temperature of the drive device to become the target temperature, and
when the vehicle remains stopped even when a predetermined second time has elapsed after staring the temperature feedback control, execute the energization control.

15. The vehicle control device according to claim 13, wherein
the energization control is speed feedback control to control the power elements based on the rotation speed of the rotary electrical machine to cause the rotary electrical machine to rotate at a target rotation speed within the predetermined slow rotation speed range.

16. The vehicle control device according to claim 15, wherein
the target rotation speed is set in accordance with an operation amount of an accelerator pedal provided to the vehicle.

17. The vehicle control device according to claim 14, wherein
the at least one of the circuit and the processor is further configured to cause the vehicle control device to execute the energization control, when temperature of the drive device has decreased to a temperature lower than the first threshold by the temperature feedback control.

18. The vehicle control device according to claim 13, wherein
the at least one of the circuit and the processor is further configured to cause the vehicle control device to output warning to a driver of the vehicle while executing the energization control.

19. The vehicle control device according to claim 13, wherein
the energization control is open-loop control.

20. The vehicle control device according to claim 19, wherein
the at least one of the circuit and the processor is further configured to cause the vehicle control device to execute the open-loop control while confirming that a change amount of a rotation angle of the rotary electrical machine is appropriate.

21. The vehicle control device according to claim 1, wherein
the at least one of the circuit and the processor is further configured to cause the vehicle control device to perform a filtering processing on target torque of the rotary electrical machine by a notch filter that is configured to attenuate a torsional resonance frequency component of a drive shaft connected to the rotary electrical machine in a manner that power can be transmitted.

22. The vehicle control device according to claim 1, wherein,
the at least one of the circuit and the processor is further configured to cause the vehicle control device to, when detecting an accelerator hill hold operation of an accelerator pedal provided to the vehicle, which is to cause the vehicle to remain stopped in a case where the vehicle rides over a level difference or travels on an uphill road, output an instruction to a brake control device, which is provided to the vehicle, to control a brake provided to the vehicle, to operate the brake.

23. The vehicle control device according to claim 22, wherein
the at least one of the circuit and the processor is further configured to cause the vehicle control device to output warning to a driver of the vehicle when the accelerator hill hold operation is detected.

24. A vehicle control device comprising:
at least one of (i) a circuit and (ii) a processor with a memory storing computer program code executable by the processor, the at least one of the circuit and the processor configured to cause the vehicle control device to:
determine, when a vehicle rides over a level difference or travels on an uphill road, whether the vehicle is in a stopped state due to load torque, which acts on a rotary electrical machine driving the vehicle and balances with torque of the rotary electrical machine;
set, when determining that the vehicle is in the stopped state, a target speed of the vehicle in accordance with an operation amount of an accelerator pedal provided to the vehicle; and
calculate target torque of the rotary electrical machine when executing feedback control to cause an actual vehicle speed of the vehicle to become the target speed.

25. A vehicle control method comprising:
estimating, by at least one processor, temperature of a drive device, which includes a rotary electrical machine configured to drive a vehicle and an inverter connected to the rotary electrical machine, based on a temperature detection value of at least one of a plurality of power elements of the inverter and a current value of each of the power elements;
in a state in which the drive device is overloaded, controlling, by the at least one processor, torque of the rotary electrical machine based on the temperature as estimated to decrease temperature of the drive device;
estimating temperature of the drive device based on the temperature detection value, when rotation speed of the rotary electrical machine is higher than predetermined rotation speed in a vicinity of a rotational stop; and
estimating temperature of the drive device based on the temperature detection value and a current value for each of the power elements, when the rotation speed of the rotary electrical machine is equal to or less than the predetermined rotation speed in the vicinity of the rotational stop.

26. A vehicle control method comprising:
determining, by at least one processor, when a vehicle rides over a level difference or travels on an uphill road, whether the vehicle is in a stopped state due to load torque, which acts on a rotary electrical machine driving the vehicle and balances with torque of the rotary electrical machine;
setting, by the at least one processor, when determining that the vehicle is in the stopped state, a target speed of the vehicle in accordance with an operation amount of an accelerator pedal provided to the vehicle; and
calculating, by the at least one processor, target torque of the rotary electrical machine when executing feedback control to cause an actual vehicle speed of the vehicle to become the target speed.

27. A non-transitory computer readable storage medium storing a program comprising instructions configured to, when executed by at least one processor, cause the at least one processor to:
estimate temperature of a drive device, which includes a rotary electrical machine configured to drive a vehicle and an inverter connected to the rotary electrical machine, based on a temperature detection value of at least one of a plurality of power elements of the inverter and a current value of each of the power elements;
in a state in which the drive device is overloaded, control torque of the rotary electrical machine based on the temperature as estimated to decrease temperature of the drive device;
estimate temperature of the drive device based on the temperature detection value, when rotation speed of the rotary electrical machine is higher than predetermined rotation speed in a vicinity of a rotational stop; and
estimate temperature of the drive device based on the temperature detection value and a current value for each of the power elements, when the rotation speed of the rotary electrical machine is equal to or less than the predetermined rotation speed in the vicinity of the rotational stop.

28. A non-transitory computer readable storage medium storing a program comprising instructions configured to, when executed by at least one processor, cause the at least one processor to:
determine, when a vehicle rides over a level difference or travels on an uphill road, whether the vehicle is in a stopped state due to load torque, which acts on a rotary electrical machine driving the vehicle and balances with torque of the rotary electrical machine;
set, when determining that the vehicle is in the stopped state, a target speed of the vehicle in accordance with an operation amount of an accelerator pedal provided to the vehicle; and
calculate target torque of the rotary electrical machine when executing feedback control to cause an actual vehicle speed of the vehicle to become the target speed.
